(19) United States
(12) Patent Application Publication
(10) Pub. No.: US 2025/0324008 A1
(43) Pub. Date: Oct. 16, 2025

(54) STORAGE MEDIUM, AND CONTROL METHOD FOR INFORMATION PROCESSING APPARATUS

(71) Applicant: CANON KABUSHIKI KAISHA, Tokyo (JP)

(72) Inventor: TAKU SHINOHARA, Saitama (JP)

(21) Appl. No.: 19/177,306

(22) Filed: Apr. 11, 2025

(30) Foreign Application Priority Data
Apr. 16, 2024 (JP) 2024-066076

(51) Int. Cl. H04N 1/00

(52) U.S. Cl. CPC H04N 1/00938; H04N 1/00474

(57) ABSTRACT

A non-transitory computer-readable storage medium stores computer-executable instructions that, when executed, cause an information processing apparatus to perform a control method. The control method includes generating an instruction executable in common by multifunction devices provided by a plurality of manufacturers, and invoking a plurality of software capable of sending the instruction to the multifunction devices provided by the plurality of manufacturers.

### BACKGROUND

### Field of the Disclosure

The present disclosure relates to a computer-readable medium storing instructions for integrating extension printing software, extension scanning software, and extension FAX software, as well as a method for information processing, an information processing apparatus, and an information processing system.

### Description of the Related Art

There is a known configuration of control software for scanning devices in which

scan instructions are provided to the scanning device connected to a host computer using a scan driver installed in the host computer.

An operating system (hereinafter referred to as “OS”), which serves as the basic software, is installed in the host computer. The scan driver is configured according to the specifications defined by the OS and operates when involved by the OS. The vendor (manufacturer) that provides the scanning device can provide a means for instructing the scanning device to scan using the OS by providing a scan driver conforming to the specifications of the OS.

Windows® has recently provided a standard class driver (hereinafter also referred to as “standard driver”) that can be commonly used with scanning devices provided by multiple vendors. Such a standard driver is packed in the OS package and can easily be used by connecting any scanning device to the host computer. This eliminates the need for separately installing a device-specific scan driver suitable for the scanning device, which enhances the convenience.

The standard driver may be configured to allow scanning functions to be specified based on scanning function information generated from information obtained from the connected scanning device. This enables users of the standard driver to specify scanning functions according to the capabilities of the connected scanning device, even though they are using a single standard driver. Standard printer drivers that provide printer functions and standard FAX drivers that provide FAX functions have also been provided.

Japanese Patent Laid-Open No. 2021-033526 discloses a program for extending the printing function of a standard printer driver.

In recent years, there have been applications and portal sites that allow both printing and scanning functions to be used in an integrated manner. However, when the scanning function is used, the standard scan driver needs to be invoked from a scanning application, and when the printing function is used, the standard printer driver needs to be invoked from a printing application. When the printing function or the scanning function is used, the user needs to switch between separate software each time, increasing the operational burden.

### SUMMARY

A non-transitory computer-readable storage medium according to an aspect of the present disclosure stores computer-executable instructions that, when executed, cause an information processing apparatus to perform a control method. The control method includes generating an instruction executable in common by multifunction devices provided by a plurality of manufacturers, and invoking a plurality of software capable of sending the instruction to the multifunction devices provided by the plurality of manufacturers.

Further features of various embodiments will become apparent from the following description of exemplary embodiments with reference to the attached drawings.

### BRIEF DESCRIPTION OF THE DRAWINGS

FIG. 1 is a block diagram illustrating the configuration of an entire system according to an embodiment.

FIGS. 2A and 2B are diagrams illustrating the software configuration according to a first embodiment.

FIG. 3 is a diagram illustrating an example of the application screen according to the first embodiment.

FIG. 4A is a diagram illustrating a screen displayed by the application according to the first embodiment.

FIG. 4B is a diagram illustrating a screen displayed by general-purpose scanning software according to the first embodiment.

FIG. 4C is a diagram illustrating a screen displayed by an extension application according to the first embodiment.

FIG. 5A is a diagram illustrating a screen displayed by the application according to the first embodiment.

FIG. 5B is a diagram illustrating a screen displayed by general-purpose printing software according to the first embodiment.

FIG. 5C is a diagram illustrating a screen displayed by an extension application according to the first embodiment.

FIG. 6A is a diagram illustrating a screen displayed by the application according to the first embodiment.

FIG. 6B is a diagram illustrating a screen displayed by general-purpose FAX software according to the first embodiment.

FIG. 6C is a diagram illustrating a screen displayed by an extension application according to the first embodiment.

FIG. 7 is a sequence chart of operations of the application, the general-purpose scanning software, the extension application, and the image forming apparatus according to the first embodiment.

FIG. 8 is a sequence chart of operations of the application, the general-purpose printing software, the extension application, and the image forming apparatus according to the first embodiment.

FIG. 9 is a sequence chart of operations of the application, the general-purpose FAX software, the extension application, and the image forming apparatus according to the first embodiment.

FIG. 10 is a flowchart of the operation of the image forming apparatus according to the first embodiment.

FIG. 11 is a flowchart of the operation of the image forming apparatus according to the first embodiment.

FIG. 12 is a flowchart of the operation of the image forming apparatus according to the first embodiment.

FIGS. 13A and 13B are diagrams illustrating the software configuration according to a second embodiment.

FIG. 14A is a diagram illustrating a screen displayed by the application according to the second embodiment.

FIG. 14B is a diagram illustrating a screen displayed by general-purpose printing software according to the second embodiment.

FIG. 14C is a diagram illustrating a screen displayed by an extension application according to the second embodiment.

FIG. 15 is a sequence chart of operations of the application, the general-purpose printing software, the extension application, and the image forming apparatus according to the second embodiment.

FIG. 16 is a diagram illustrating the software configuration according to a third embodiment.

FIG. 17 is a sequence chart of operations of the application, the extension scanning application, and the image forming apparatus according to the third embodiment.

FIG. 18 is a sequence chart of operations of the application, the extension printing application, and the image forming apparatus according to the third embodiment.

FIG. 19 is a sequence chart of operations of the application, the extension FAX application, and the image forming apparatus according to the third embodiment.

FIG. 20A is a diagram illustrating a screen displayed by the extension scanning application according to the third embodiment.

FIG. 20B is a diagram illustrating a screen displayed by the extension printing application according to the third embodiment.

FIG. 20C is a diagram illustrating a screen displayed by the extension FAX application according to the third embodiment.

FIG. 21 is a flowchart of the operation of the application according to a fourth embodiment.

FIG. 22 is a diagram illustrating an example of the application screen according to the fourth embodiment.

### DESCRIPTION OF THE EMBODIMENTS

Embodiments of the present disclosure will be described hereinbelow with reference to the accompanying drawings. It is to be understood that the following embodiments do not limit every embodiment according to the claims and that not all of the combinations described in the embodiments are required for the solutions of the present disclosure.

### First Embodiment

### Hardware Configuration of System

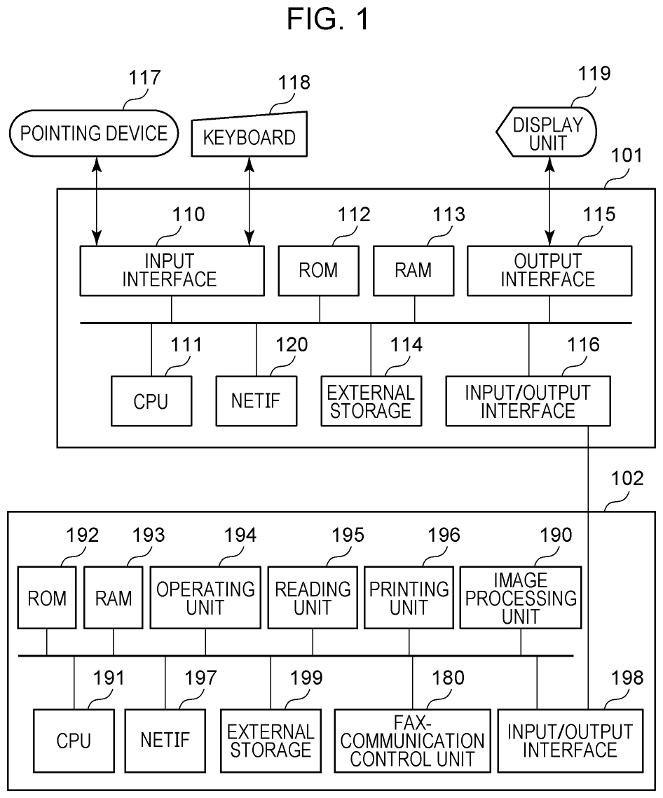

FIG. 1 is a block diagram illustrating the hardware configuration of a system. In FIG. 1, a host computer 101 is an example of an information processing apparatus, which includes an input interface 110, a central processing unit (CPU) 111, a read only memory (ROM) 112, a random-access memory (RAM) 113, an external storage 114, an output interface 115, and an input/output interface 116.

The input interface 110 connects to input devices including a keyboard 118 and a pointing device 117. The output interface 115 connects to a display device, such as a display unit 119. A network interface (NETIF) 120 performs control for transferring data to/from an external device via a network.

The ROM 112 stores initialization programs. Examples of the external storage 114 include a hard disk drive (HDD) and a solid-state drive (SSD). The external storage 114 stores application programs, an operating system (OS), and various items of data. The RAM 113 is used as a work memory or the like in executing various programs stored in the external storage 114 to allow the various programs to operate in the host computer 101.

In this embodiment, the CPU 111 performs processes according to the codes of the programs stored in the ROM 112 and the external storage 114 to execute the functions of the host computer 101 and the processes of the flowcharts, described below.

An image forming apparatus 102 is an example of a multifunction device. The image forming apparatus 102 is connected to the host computer 101 via an input/output interface 198 of the image forming apparatus 102 and the input/output interface 116 of the host computer 101. The input/output interface 198 of the image forming apparatus 102 and the input/output interface 116 of the host computer 101 may be connected via a wired or wireless network.

The image forming apparatus 102 includes an image processing unit 190, a CPU 191, a ROM 192, a RAM 193, an operating unit 194, a reading unit 195, a printing unit 196, a NETIF 197, an input/output interface 198, and a FAX-communication control unit 180.

The CPU 191 controls the image forming apparatus 102 as a whole. The ROM 192 is a memory that stores programs. The RAM 193 is a memory that temporarily stores the programs and image data. The reading unit 195 is a scanner, which reads images of documents. The printing unit 196 prints images on sheets based on image data. The NETIF 197 is a network interface that performs control for data transfer to/from an external device via a network. The image processing unit 190 performs various image editing processes on the input image data. The FAX-communication control unit 180 performs FAX communication over the telephone lines.

Here, the host computer 101 and the image forming apparatus 102 are separately configured, but they may be configured as a single information processing apparatus. The settings screen and the advanced-settings screen, described below, are displayed on the display unit 119.

In this embodiment, the image forming apparatus 102 will be described using an electrophotographic digital multifunction device having multiple functions, such as copying, printing, and faxing, as an example. This, however, is illustrative only. This embodiment is also applicable to devices that use an ink-jet method or other processes and scanners that read only images. The host computer 101 may be a desktop personal computer, a smartphone, or a notebook personal computer.

### System Configuration Centered on Software

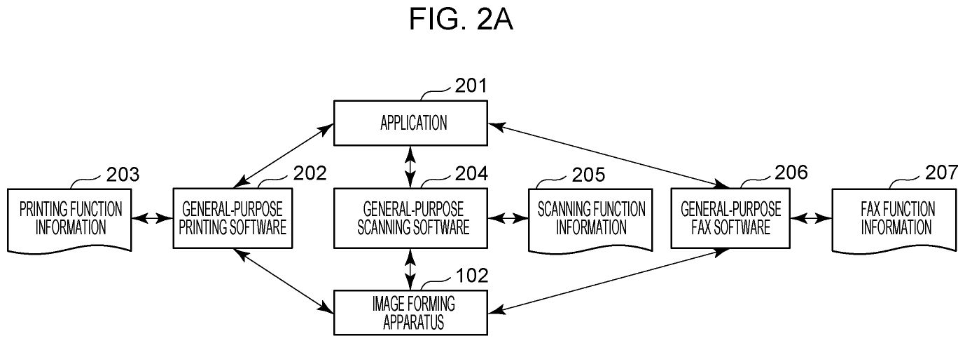

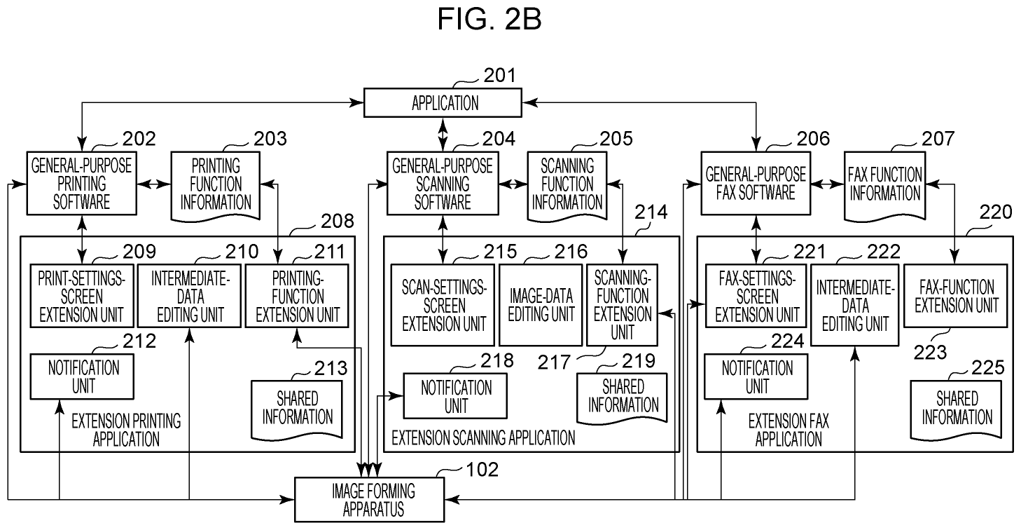

FIGS. 2A and 2B schematically illustrate the software configuration of the system. The software configuration in FIGS. 2A and 2B is stored in the external storage 114 of FIG. 1. Here, the explanation is based on a system that uses the host computer 101 equipped with Microsoft® Windows® 11 as its OS.

FIG. 2A is a diagram illustrating a general configuration in which extension applications 208, 214, and 220 are not associated with general-purpose software 202, 204, and 206, respectively, and are not associated with the image forming apparatus 102. FIG. 2B is a diagram illustrating a configuration in which the extension applications 208, 214, and 220 are associated with the general-purpose software 202, 204, and 206, respectively, and are associated with the image forming apparatus 102.

System Configuration Centered on Software (when Extension Applications 208, 214, and 220 are not Associated)

First, the configuration of the system in the case where the extension applications 208, 214, and 220 are not associated will be described with reference to FIG. 2A.

The application 201 is software that allows multiple functions of the image forming apparatus, such as printing, scanning, and FAX, to be used. In response to a request from the user, the application 201 issues instructions to the OS. For example, scan instructions include scan settings information for specifying the operations of the general-purpose scanning software 204 and the image forming apparatus 102.

In this configuration, the general-purpose software is invoked from the native application. This is however illustrative only. The general-purpose software may be invoked from a web application or web site on a browser or may be operated as part of an integrated system.

Print instructions include print settings information for specifying the operation of the general-purpose printing software 202 and the image forming apparatus 102. The print settings information is also referred to as PrintTicket (hereinafter referred to as “PT”).

The application 201 can display print-settings screen provided by the general-purpose printing software 202, OS, or the application 201 to output PT. When the advanced settings button in the print-settings screen is pressed, the general-purpose printing software 202 additionally displays an advanced-settings screen. The print-settings screen and the advanced-settings screen will be described below.

The advanced-settings screen includes setting items indicating configurable printing functions (hereinafter referred to as “control items”) and control items indicating their setting values according to the capability information (configurable information) from the general-purpose printing software 202. The general-purpose printing software 202 determines the capability information based on printing function information 203. The printing function information 203 is data that indicates printing functions including all configurable printing functions (setting items), their setting values, and the exclusion relationship among the setting values.

The printing function information 203 is included in the configuration file of the general-purpose printing software 202 and is saved in the external storage 114 as an unchangeable file. Also, the printing function information 203 may be dynamically generated by the general-purpose printing software 202. Specifically, the general-purpose printing software 202 or the OS may be configured to obtain the attribute data of the image forming apparatus 102 from the image forming apparatus 102 and generate the printing function information 203 according to the attribute information in the obtained attribute data.

The printing function information 203, if dynamically generated, can be edited. The attribute data of the image forming apparatus 102 can be obtained by issuing a Get-Printer-Attributes operation of Internet print protocol (IPP) to the image forming apparatus 102. Its response includes attribute information indicating functions that can be specified by the image forming apparatus 102 (the capability of the printer) and setting values related to the attribute information. This response is stored in the RAM 113.

This configuration of the general-purpose printing software 202 allows the user to specify printing functions available across all the image forming apparatuses 102 according to the connected image forming apparatus 102. In other words, even if an image forming apparatus with different functions or an image forming apparatus developed by a different vendor is connected, the general-purpose printing software 202 allows the user to specify available printing functions according to the connected image forming apparatus 102. The vendor may be the manufacturer of the image forming apparatus 102.

Here, the general-purpose printing software 202 utilizes an IPP class driver installed in Windows® 11. The IPP class driver is a printer driver that executes a print process in accordance with the specifications of a standard print protocol called IPP and is included in the OS package. In other words, when an information processing apparatus with a pre-installed OS is purchased, the IPP class driver is available for use without the need for download.

The IPP class driver is not a printer driver unique to the model of the image forming apparatus 102 but a standard class driver that can be commonly used by printers from multiple manufacturers. In other words, the print data generated by the IPP class driver can be printed by the printers from multiple manufacturers, and the IPP class driver can send print data to the printers from multiple manufacturers. Similarly, the general-purpose scanning software 204 and the general-purpose FAX software 206 can also be used with devices from multiple manufacturers.

The IPP class driver obtains the capability information of the connected image forming apparatus 102 and generates the printing function information 203 based on the information so that the user can specify printing functions supported by the image forming apparatus 102.

When print instructions are issued from the application 201, the module of the OS in the general-purpose printing software 202 generates intermediate data (also referred to as input data). The data that the application 201 outputs for printing is data in the Graphic Device Interface (GDI) format or data in the XML Paper Specification (XPS) format.

Assume that the IPP class driver is used as the general-purpose printing software 202. In this case, if the data output from the application 201 is GDI-format data, the OS converts the GDI-format data output from the application 201 to XPS-format data. The intermediate data includes drawing data, which represents the information of the drawing formed on the paper surface, and the PT set by the user.

The general-purpose printing software 202 converts the obtained intermediate data to print data that can be interpreted by the image forming apparatus 102 and sends the print data to the image forming apparatus 102. Here, the print data in this embodiment is Page Description Language (PDL) data conforming to the IPP. Examples of the PDL data conforming to the IPP include portable document format (PDF) data and PWG-Raster format data.

The print data includes drawing data, which is the information of the drawing formed on the paper surface, and print-settings attribute information (attribute information that specifies the print setting values) generated based on the PT that is set by the user. The print-settings attribute information includes attribute information indicating the functions (the capability of the printer) that can be specified by the image forming apparatus 102 and setting values related to the attribute information.

The image forming apparatus 102 prints on a medium, such as a paper surface, based on the print data sent from the general-purpose printing software 202. At that time, the image forming apparatus 102 forms the drawing data included in the print data onto the medium, operating in accordance with the print-settings attribute information included in the print data.

The print-settings attribute information includes the print quality (priority on image quality, priority on speed, etc.), attribute information for specifying double-sided printing, etc., and their setting values. For example, when the print-settings attribute information includes attribute information that specifies double-sided printing and its setting value for operating the double-sided printing, the image forming apparatus 102 executes double-sided printing.

The application 201 can display a scan-settings screen provided by the general-purpose scanning software 204, OS, or the application 201 to execute scan instructions. When the advanced settings button in the scan-settings screen is pressed, the general-purpose scanning software 204 additionally displays an advanced-settings screen. The scan-settings screen and the advanced-settings screen will be described below.

The advanced-settings screen includes setting items indicating configurable scanning functions (hereinafter referred to as “control items”) according to the capability information (configurable information) from the general-purpose scanning software 204 and control items indicating their setting values. The general-purpose scanning software 204 determines the scanning capability based on scanning function information 205. The scanning function information 205 is data that indicates scanning functions including all configurable scanning functions (setting items), their setting values, and the exclusion relationship among the setting values.

The scanning function information 205 is included in the configuration file of the general-purpose scanning software 204 and is saved in the external storage 114 as an unchangeable file. Also, the scanning function information 205 may be dynamically generated by the general-purpose scanning software 204. Specifically, the general-purpose scanning software 204 or the OS may be configured to obtain the attribute data of the image forming apparatus 102 from the image forming apparatus 102 and generate the scanning function information 205 according to the attribute information in the obtained attribute data.

The scanning function information 205, if dynamically generated, can be edited. The attribute data of the image forming apparatus 102, which has been obtained from the image forming apparatus 102, includes attribute information indicating functions that can be specified by the image forming apparatus 102 (the capability of the scanning device) and setting values related to the attribute information. This information is stored in the RAM 113.

The application 201 can display a FAX-settings screen provided by the general-purpose FAX software 206, OS, or the application 201 to execute FAX instructions. When the advanced settings button in the FAX-settings screen is pressed, the general-purpose FAX software 206 additionally displays an advanced-settings screen. The FAX-settings screen and the advanced-settings screen will be described below.

The advanced-settings screen includes setting items indicating configurable FAX functions (hereinafter referred to as “control items”) according to the capability information (configurable information) from the general-purpose FAX software 206 and control items indicating their setting values. The general-purpose FAX software 206 determines the FAX capabilities based on FAX function information 207.

The FAX function information 207 is data that indicates FAX functions including all configurable FAX functions, their setting values, and the exclusion relationship among the setting values. The FAX function information 207 is included in the configuration file of the general-purpose FAX software 206 and is saved in the external storage 114 as an unchangeable file.

Also, the FAX function information 207 may be dynamically generated by the general-purpose FAX software 206. Specifically, the general-purpose FAX software 206 or the OS may be configured to obtain the attribute data of the image forming apparatus 102 from the image forming apparatus 102 and generate the FAX function information 207 according to the attribute information in the obtained attribute data.

The FAX function information 207, if dynamically generated, can be edited. The attribute data of the image forming apparatus 102 obtained from the image forming apparatus 102 includes attribute information indicating functions that can be specified by the image forming apparatus 102 (the capability of the FAX device) and setting values related to the attribute information. This information is stored in the RAM 113.

This configuration of the general-purpose software 202, 204, and 206 allows the user to specify functions available across all the image forming apparatuses 102 according to the connected image forming apparatus 102. In other words, even if an image forming apparatus with different functions or an image forming apparatus developed by a different vendor is connected, the general-purpose software 202, 204, and 206 allows the user to specify available functions according to the connected image forming apparatus 102.

The vendor may be the manufacturer of the image forming apparatus 102. Here, the general-purpose software 202, 204, and 206 are standard-class drivers for executing printing, scanning, and FAX operations based on a standard scan protocol called Mopria. The general-purpose software 202, 204, and 206 obtain the capability information of the connected image forming apparatus 102 and generate the function information 203, 205, and 207, respectively, based on the information so that the user can specify functions supported by the connected image forming apparatus 102.

### System Configuration Centered on Software (when Extension Applications 208, 214, and 220 are Associated)

First, the configuration of the system in the case where the extension applications 208, 214, and 220 are associated will be described with reference to FIG. 2B. Unless otherwise specified below, the components and processes are the same as those of FIG. 2A.

The extension printing application 208 is software for extending and supporting the functions of the general-purpose printing software 202 and is not contained (packed) in advance in the OS. For this reason, the user needs to operate the host computer 101 to download the extension printing application 208 from the server via the Internet and install it.

Also, the extension printing application 208 may be automatically installed in response to connection of the image forming apparatus 102 to the host computer 101. Specifically, when the image forming apparatus 102 is connected to the host computer 101, the OS obtains device identification information from the image forming apparatus 102. The OS may download the extension printing application 208 corresponding to the obtained device identification information from the server via the Internet, and install it. In other words, the general-purpose printing software 202 and the extension printing application 208 are stored in the host computer 101 as different files.

The general-purpose printing software 202 and the extension printing application 208 may be updated and version-upgraded. These update processes are carried out at separate times. In other words, the timing when the general-purpose printing software 202 is obtained and the timing when the extension printing application 208 is obtained by the host computer 101 are different.

The trigger to obtain the general-purpose printing software 202 and the trigger to obtain the extension printing application 208 by the host computer 101 are also different. When the extension printing application 208 is installed, the OS associates the extension printing application 208 with the general-purpose printing software 202 and the image forming apparatus 102.

The extension printing application 208 described in this embodiment includes a print-settings-screen extension unit 209, a printing-function extension unit 211, an intermediate-data editing unit 210, and a notification unit 212.

The extension printing application 208 further includes shared information 213 accessible from each unit. The actual form of the shared information 213 is a file stored in the external storage 114 or information stored on the RAM 113. The extension printing application 208 writes and reads information to/from the shared information 213 by using an application program interface (API) provided by the OS.

The extension printing application 208 may terminate the operation every time the process of each unit is completed. In that case, the OS starts the extension printing application 208 every time a request to use the unit is provided.

Furthermore, the extension printing application 208 may cancel the process of each unit during the process. If the process is cancelled, the job being processed is deleted by the OS.

In response to receiving a print request from the user, the application 201 issues print instructions to the OS. In this configuration as well, the application 201 can display a print-settings screen, as with the configuration of FIG. 2A. In this configuration, an advanced-settings screen provided by the extension printing application 208 is displayed. Specifically, an advanced-settings screen provided by the print-settings-screen extension unit 209 of the extension printing application 208 is displayed. The print-settings-screen extension unit 209 can store advanced setting values set by the user in the shared information 213.

The extension printing application 208 includes the intermediate-data editing unit 210. The intermediate-data editing unit 210 obtains intermediate data from the general-purpose printing software 202 and edits the intermediate data. The intermediate-data editing unit 210 converts the intermediate data to print data and thereafter sends the print data to the image forming apparatus 102. The intermediate-data editing unit 210 obtains advanced settings information from the shared information 213 and adds the advanced setting values to the print data.

The image forming apparatus 102 prints on the paper surface based on the received print data.

A method for converting the intermediate data to print data is not limited to the above method. The conversion from the intermediate data to print data may be performed by the general-purpose printing software 202. Also, the extension printing application 208 may obtain print data generated by the general-purpose printing software 202 and add advanced setting values to the print data. In the configuration of FIG. 2B as well, the general-purpose printing software 202 may transfer the print data to the image forming apparatus 102 without passing through the extension printing application 208, as in the configuration of FIG. 2A.

The extension printing application 208 includes the printing-function extension unit 211. The printing-function extension unit 211 can edit the printing function information 203 generated by the general-purpose printing software 202 or the OS. This allows the printing-function extension unit 211 to add functions to be provided by the extension printing application 208.

The printing-function extension unit 211 can also add a function that is supported by the image forming apparatus 102 but is not supported by the general-purpose printing software 202, the exclusion relationship among the setting values of the printing functions, and so on. When the extension printing application 208 is first associated with the image forming apparatus 102 and the general-purpose printing software 202, the OS starts the printing-function extension unit 211. The OS may start the printing-function extension unit 211 when the OS is started or at another time.

The extension printing application 208 includes the notification unit 212. The notification unit 212 can display a notification to the user in response to the occurrence of an error in the image forming apparatus 102. For example, when an out-of-paper error occurs in the image forming apparatus 102, the general-purpose printing software 202 detects the error, and the OS causes the display unit 119 to display a message using a notification function called a toast notification, which is a function of the OS.

When the toast notification is pressed by the user, the notification unit 212 of the extension printing application 208 is invoked by the OS, and the user interface (UI) screen of the notification unit 212 is displayed.

On the UI screen of the notification unit 212, for example, a detailed message for the out-of-paper error or a method for loading paper can be displayed.

The configuration of the extension printing application 208 for implementing this embodiment is not limited to one that includes all of the above-described functions (units) and may include only some of the functions or additional functions. The extension printing application 208 may also be referred to simply as printing software.

Thus, the extension printing application 208 includes at least one of the following functions. The first function is the function to display the settings screen (the print-settings-screen extension unit 209). The second function is the function to edit the intermediate data to convert it to print data and to add advanced setting values to the print data (the intermediate-data editing unit 210). The third function is the function to extend the functions that can be specified by print-data generating software (the printing-function extension unit 211). The fourth function is the function to display a screen in response to the occurrence of an error in the image forming apparatus 102 (the notification unit 212).

The extension scanning application 214 is software for extending and supporting the functions of the general-purpose scanning software 204 and is not contained (packed) in advance in the OS. For this reason, the user needs to operate the host computer 101 to download the extension scanning application 214 from the server via the Internet and install it.

Also, the extension scanning application 214 may be automatically installed in response to connection of the image forming apparatus 102 to the host computer 101. Specifically, when the image forming apparatus 102 is connected to the host computer 101, the OS obtains device identification information from the image forming apparatus 102. The OS may download the extension scanning application 214 corresponding to the obtained device identification information from the server via the Internet, and install it.

In other words, the general-purpose scanning software 204 and the extension scanning application 214 are stored in the host computer 101 as different files.

The general-purpose scanning software 204 and the extension scanning application 214 may be updated and version-upgraded. These update processes are carried out at separate times. In other words, the timing when the general-purpose scanning software 204 is obtained and the timing when the extension scanning application 214 is obtained by the host computer 101 are different.

The trigger to obtain the general-purpose scanning software 204 and the trigger to obtain the extension scanning application 214 by the host computer 101 are also different. When the extension scanning application 214 is installed, the OS associates the extension scanning application 214 with the general-purpose scanning software 204 and the image forming apparatus 102.

The extension scanning application 214 described in this embodiment includes a scan-settings-screen extension unit 215, a scanning-function extension unit 217, an image-data editing unit 216, and a notification unit 218. The extension scanning application 214 further includes shared information 219 accessible from each unit.

The actual form of the shared information 219 is a file stored in the external storage 114 or information stored on the RAM 113. The extension scanning application 214 writes and reads information to/from the shared information 219 by using an API provided by the OS.

The extension scanning application 214 may terminate the operation every time the process of each unit is completed. In that case, the OS starts the extension scanning application 214 every time a request to use the unit is provided.

Furthermore, the extension scanning application 214 may cancel the process of each unit during the process. If the process is cancelled, the job being processed is deleted by the OS.

In response to receiving a scan request from the user, the application 201 issues print instructions to the OS. In this configuration as well, the application 201 can display a scan-settings screen, as with the configuration of FIG. 2A. In this configuration, an advanced-settings screen provided by the extension scanning application 214 is displayed. Specifically, an advanced-settings screen provided by the scan-settings-screen extension unit 215 of the extension scanning application 214 is displayed. The scan-settings-screen extension unit 215 can store advanced setting values set by the user in the shared information 219.

The extension scanning application 214 includes the image-data editing unit 216. The image-data editing unit 216 obtains image data from the image forming apparatus 102 and edits the image data. The image-data editing unit 216 obtains advanced settings information from the shared information 219 and performs image editing on the image data according to the advanced setting values. The extension scanning application 214 may be configured to obtain image data obtained by the general-purpose scanning software 204 and perform image editing on the image data according to the advanced setting values.

In the configuration of FIG. 2B as well, there may be cases where the user does not perform advanced settings. In that case, the general-purpose scanning software 204 may issue instructions to scan to the image forming apparatus 102 without passing through the extension scanning application 214, as in the configuration of FIG. 2A.

The extension scanning application 214 includes the scanning-function extension unit 217.

The scanning-function extension unit 217 can edit the scanning function information 205 generated by the general-purpose scanning software 204 or the OS. This allows the scanning-function extension unit 217 to add the functions provided by the extension scanning application 214.

The scanning-function extension unit 217 can also add a function that is supported by the image forming apparatus 102 but is not supported by the general-purpose scanning software 204, the exclusion relationship among the setting values of the scanning functions, and so on. When the extension scanning application 214 is first associated with the image forming apparatus 102 and the general-purpose scanning software 204, the OS starts the scanning-function extension unit 217. The OS may start the scanning-function extension unit 217 when the OS is started or at another time.

The extension scanning application 214 includes the notification unit 218. The notification unit 218 can display a notification to the user in response to the occurrence of an error in the image forming apparatus 102. For example, when a scan jam error occurs in the image forming apparatus 102, the general-purpose scanning software 204 detects the error, and the OS causes the display unit 119 to display a message using a notification function called a toast notification, which is a function of the OS.

When the toast notification is pressed by the user, the notification unit 218 of the extension scanning application 214 is invoked by the OS, and the UI screen of the notification unit 218 is displayed. On the UI screen of the notification unit 218, for example, a detailed message for the scan jam error or a method for clearing the jam can be displayed.

The configuration of the extension scanning application 214 for implementing this embodiment is not limited to one that includes all of the above-described functions (units) and may include only some of the functions or additional functions. The extension scanning application 214 may also be simply referred to as scanning software.

Thus, the extension scanning application 214 includes at least one of the following functions. The first function is the function to display the settings screen (the scan-settings-screen extension unit 215). The second function is the function to edit the image data according to the advanced setting values (the image-data editing unit 216). The third function is the function to extend the functions that can be specified by image-data generating software (the scanning-function extension unit 217). The fourth function is the function to display a screen in response to the occurrence of an error in the image forming apparatus 102 (the notification unit 218).

The extension FAX application 220 is software for extending and supporting the functions of the general-purpose FAX software 206 and is not contained (packed) in advance in the OS. For this reason, the user needs to operate the host computer 101 to download the extension FAX application 220 from the server via the Internet and install it.

Also, the extension FAX application 220 may be automatically installed in response to connection of the image forming apparatus 102 to the host computer 101. Specifically, when the image forming apparatus 102 is connected to the host computer 101, the OS obtains device identification information from the image forming apparatus 102. The OS may download the extension FAX application 220 corresponding to the obtained device identification information from the server via the Internet, and install it. In other words, the general-purpose FAX software 206 and the extension FAX application 220 are stored in the host computer 101 as different files.

The general-purpose FAX software 206 and the extension FAX application 220 may be updated and version-upgraded. These update processes are carried out at separate times. In other words, the timing when the general-purpose FAX software 206 is obtained and the timing when the extension FAX application 220 is obtained by the host computer 101 are different.

The trigger to obtain the general-purpose FAX software 206 and the trigger to obtain the extension FAX application 220 by the host computer 101 are also different. When the extension FAX application 220 is installed, the OS associates the extension FAX application 220 with the general-purpose FAX software 206 and the image forming apparatus 102.

The extension FAX application 220 described in this embodiment includes a FAX-settings-screen extension unit 221, a FAX-function extension unit 223, an intermediate-data editing unit 222, and a notification unit 224. The extension FAX application 220 further includes shared information 225 accessible from each unit.

The actual form of the shared information 225 is a file stored in the external storage 114 or information stored on the RAM 113. The extension FAX application 220 writes and reads information to/from the shared information 225 by using an API provided by the OS.

The extension FAX application 220 may terminate the operation every time the process of each unit is completed. In that case, the OS starts the extension FAX application 220 every time a request to use the unit is provided.

Furthermore, the extension FAX application 220 may cancel the process of each unit during the process. If the process is cancelled, the job being processed is deleted by the OS.

In response to receiving a FAX transmission request from the user, the application 201 issues FAX transmission instructions to the OS. In this configuration as well, the application 201 can display a FAX-settings screen, as with the configuration of FIG. 2A. In this configuration, an advanced-settings screen provided by the extension FAX application 220 is displayed. Specifically, an advanced-settings screen provided by the FAX-settings-screen extension unit 221 of the extension FAX application 220 is displayed. The FAX-settings-screen extension unit 221 can store advanced setting values set by the user in the shared information 225.

The extension FAX application 220 includes the intermediate-data editing unit 222. The intermediate-data editing unit 222 obtains intermediate data from the general-purpose FAX software 206, converts the intermediate data to transmit data, and thereafter sends the transmit data to the image forming apparatus 102. The intermediate-data editing unit 222 obtains advanced settings information from the shared information 225 and adds the advanced setting values to the transmit data. The image forming apparatus 102 transmits based on the received transmit data.

A method for converting the intermediate data to transmit data is not limited to the above method. Also, the extension FAX application 220 may obtain transmit data generated by the general-purpose FAX software 206 and add advanced setting values to the transmit data. In the configuration of FIG. 2B as well, the general-purpose FAX software 206 may transfer the transmit data to the image forming apparatus 102 without passing through the extension FAX application 220, as in the configuration of FIG. 2A.

The extension FAX application 220 includes the FAX-function extension unit 223. The FAX-function extension unit 223 can edit the FAX function information 207 generated by the general-purpose FAX software 206 or the OS. This allows the FAX-function extension unit 223 to add functions provided by the extension FAX application 220.

The FAX-function extension unit 223 can also add a function that is supported by the image forming apparatus 102 but is not supported by the general-purpose FAX software 206, the exclusion relationship among the setting values of the FAX functions, and so on. When the extension FAX application 220 is first associated with the image forming apparatus 102 and the general-purpose FAX software 206, the OS starts the FAX-function extension unit 223. The OS may start the FAX-function extension unit 223 when the OS is started or at another time.

The extension FAX application 220 includes the notification unit 224. The notification unit 224 can display a notification to the user in response to the occurrence of an error in the image forming apparatus 102. For example, when a like-connection error occurs in the image forming apparatus 102, the general-purpose FAX software 206 detects the error, and the OS causes the display unit 119 to display a message using a notification function called a toast notification, which is a function of the OS.

When the toast notification is pressed by the user, the notification unit 224 of the extension FAX application 220 is invoked by the OS, and the UI screen of the notification unit 224 is displayed. On the UI screen of the notification unit 224, for example, a detailed message for the error or a method for handling the error can be displayed.

The configuration of the extension FAX application 220 for implementing this embodiment is not limited to one that includes all of the above-described functions (units) and may include only some of the functions or additional functions. The extension FAX application 220 may also be simply referred to as FAX software.

Thus, the extension FAX application 220 includes at least one of the following functions. The first function is the function to display the settings screen (the FAX-settings-screen extension unit 221). The second function is the function to edit the intermediate data to convert it to transmit data and to add advanced setting values to the transmit data (the intermediate-data editing unit 222). The third function is the function to extend the functions that can be specified by transmit-data generating software (the FAX-function extension unit 223). The fourth function is the function to display a screen in response to the occurrence of an error in the image forming apparatus 102 (the notification unit 224).

The configuration of the system for implementing this embodiment is not limited to one that includes all of the general-purpose printing software 202, the general-purpose scanning software 204, and the general-purpose FAX software 206 but may include only some of the functions or other functions. Examples of the configuration may be one that includes only the general-purpose scanning software 204 and one that includes image-transmitting software over a network, in addition to the three general-purpose software.

The general-purpose printing software 202, the general-purpose scanning software 204, and the general-purpose FAX software 206 are examples of software that can generate and transmit instructions that can be commonly executed by multifunction devices provided by multiple manufacturers. The extension applications 208, 214, 220, and 1301 (described below) are examples of a support application.

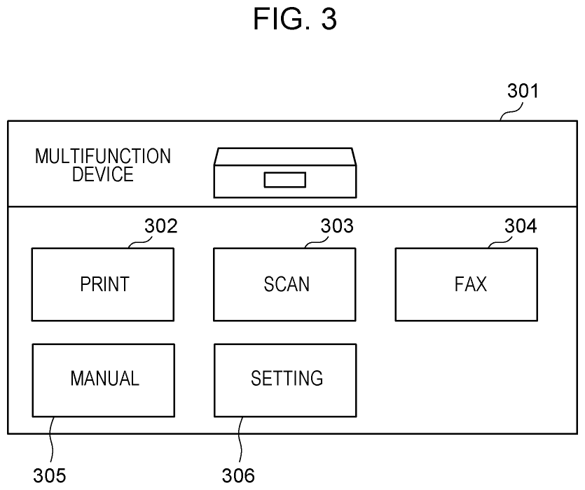

Next, an example of the application screen according to this embodiment will be described with reference to FIG. 3. Reference numeral 301 denotes a screen displayed by the application 201. A control 302 is a print button. When the control 302 is pressed, the general-purpose printing software 202 is activated. A control 303 is a scan button. When the control 303 is pressed, the general-purpose scanning software 204 is activated. A control 304 is a FAX button. When the control 304 is pressed, the general-purpose FAX software 206 is activated.

A control 305 is a manual button. When the control 305 is pressed, the manual embedded in the application 201 is opened. Also, an on-line manual on the Internet may be accessed. A control 306 is a setting button. When the control 306 is pressed, the configurable settings of the image forming apparatus 102 are displayed.

The configuration of the application for implementing this embodiment is not limited to this configuration. Examples include a configuration including a control button for sending images via a network or a control button for the function to store images in a cloud server.

### Examples of Scan-Settings Screen/Advanced-Settings Screen

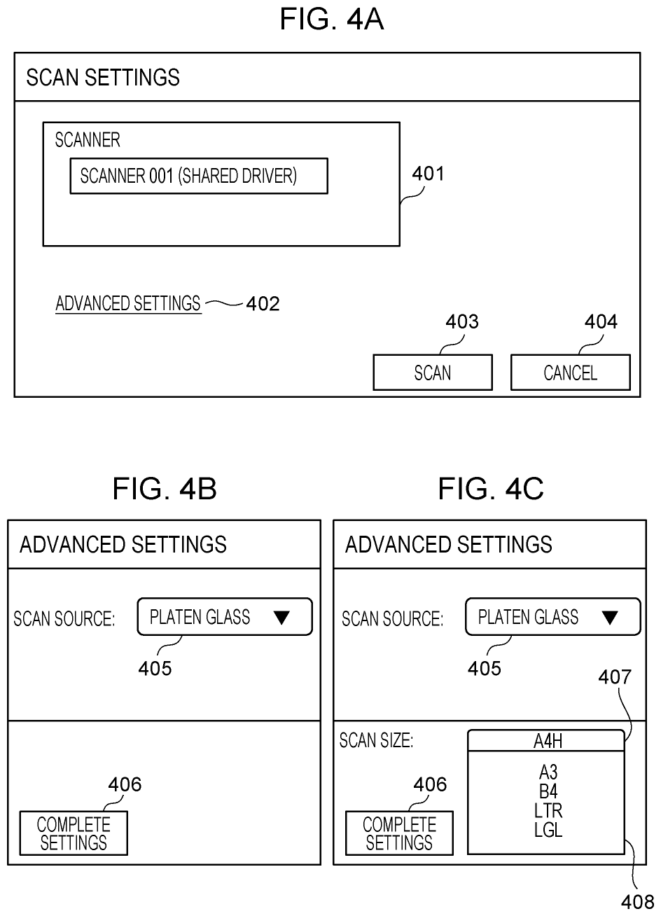

Next, examples of the scan-settings screen and the advanced-settings screen according to this embodiment will be described with reference to FIGS. 4A to 4C. FIG. 4A illustrates a scan-settings screen displayed by the application 201. FIG. 4B illustrates an advanced-settings screen displayed when the extension scanning application 214 illustrated in FIG. 2A is not present. FIG. 4C illustrates an advanced-settings screen when the extension scanning application 214 illustrated in FIG. 2B is present.

The units and modules for displaying the scan-settings screens are not limited to the above. For example, the scan-settings-screen extension unit 215 may only generate a display screen. In this case, the scan-settings-screen extension unit 215 sends the generated display screen to the application 201 via the general-purpose scanning software 204. The application 201 may be configured to display the obtained display screen.

### FIG. 4A Scan-Settings Screen Displayed by Application 201

First, FIG. 4A will be described. A control 401 includes objects to prompt the user to set a scanner to be used to scan image data (a scanner to be used for scanning). A control 403 is a scan start button. A control 404 is a scan cancel button. A control 402 is an advanced settings button. When the control 402 is pressed, an additional scan screen is displayed by the general-purpose scanning software 204 or the scan-settings-screen extension unit 217.

### FIG. 4B Advanced-Settings Screen Displayed by General-Purpose Scanning Software 204

Second, FIG. 4B will be described. FIG. 4B illustrates an additional settings screen displayed by the general-purpose scanning software 204 when the extension scanning application 214 is not present. A control 405 is a button that allows for setting a scan source, indicating that “Platen Glass” is selected. A control 406 is a complete-settings button. When the control 406 is pressed, the screen returns to the scan-settings screen of FIG. 4A.

### FIG. 4C Advanced-Settings Screen Displayed by Scan-Settings-Screen Extension Unit 215

Next, FIG. 4C will be described. FIG. 4C illustrates an additional settings screen displayed by the scan-settings-screen extension unit 215 when the extension scanning application 214 is present. Unlike FIG. 4B, a control 407 and a list 408 are added.

The control 407 is a button that allows for selecting a scan-size specification setting, which indicates that “A4H” is currently selected. When the control 407 is pressed, the list 408 shows setting values for the scan-size specification setting. The list 408 indicates that, in addition to the currently selected “A4H”, there are setting values for “A3”, “B4”, “LTR”, and “LGL”. The user switches the scan-size function to perform scanning by selecting the size-setting value for a desired scan size from the list 408.

The reason why the scan setting items differ between FIG. 4B and FIG. 4C will be described.

The advanced-settings screen is generated with reference to scan capabilities generated based on the scanning function information 205. However, since the general-purpose scanning software 204 does not support the scan-size specification function, the scan-size specification function cannot be added to the scanning function information 205. Even if the scanning function information 205 originally includes the scan-size specification function, the general-purpose scanning software 204 cannot interpret the scan-size specification function included in the scanning function information 205, and therefore cannot display the scan-size specification setting on the advanced-settings screen.

For this reason, the scanning-function extension unit 217 is configured to add the scan-size specification function to the scanning function information 205 so that the scan-settings-screen extension unit 215 can display the advanced-settings screen with reference to the scan capabilities. This configuration enables the extension scanning application 214 to display the scan-size specification setting on the advanced-settings screen. FIG. 4C may additionally include extended functions other than the scan-size specification function.

### Examples of Print-Settings Screen/Advanced-Settings Screen

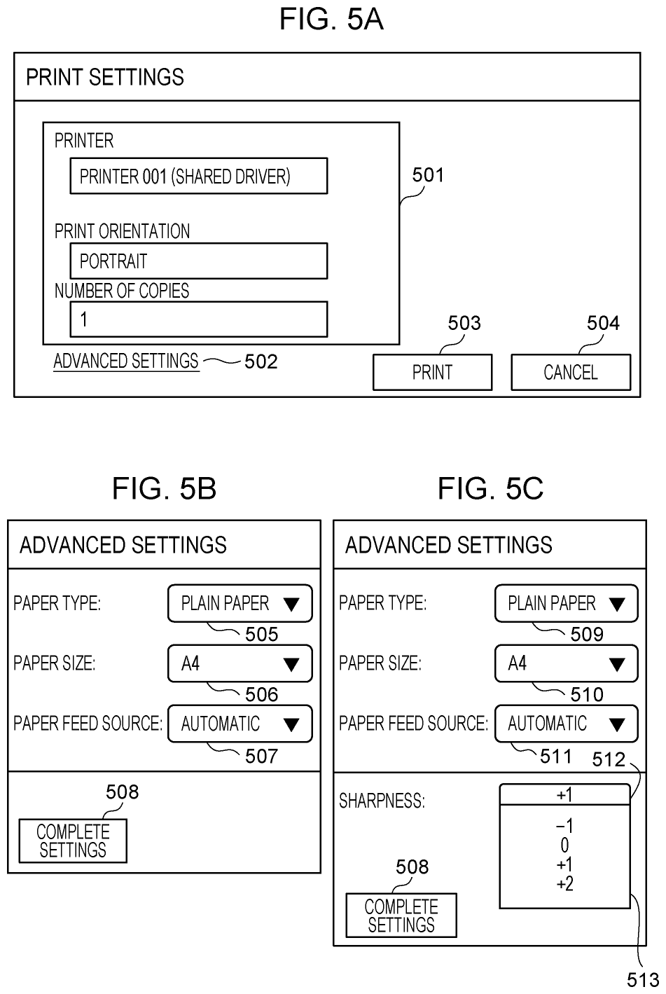

Next, examples of the print-settings screen and the advanced-settings screen according to this embodiment will be described with reference to FIGS. 5A to 5C. FIG. 5A illustrates a print-settings screen displayed by the application 201.

FIG. 5B illustrates an advanced-settings screen displayed when the extension printing application 208 illustrated in FIG. 2A is not present. FIG. 5C illustrates an advanced-settings screen when the extension printing application 208 illustrated in FIG. 2B is present.

The units and modules for displaying the print-settings screens are not limited to the above. For example, the print-settings-screen extension unit 209 may only generate a display screen. In this case, the print-settings-screen extension unit 209 sends the generated display screen to the application 201 via the general-purpose printing software 202. The application 201 may be configured to display the obtained display screen.

### FIG. 5A Print-Settings Screen Displayed by Application 201

First, FIG. 5A will be described. A control 501 includes objects to prompt the user to set a printer (a printer to be used for printing) that is the destination of the image data, a print orientation, and the number of copies. A control 503 is a print start button. A control 504 is a print cancel button. A control 502 is an advanced settings button. When the control 502 is pressed, an additional print screen is displayed by the general-purpose printing software 202 or the print-settings-screen extension unit 209.

### FIG. 5B Advanced-Settings Screen Displayed by General-Purpose Printing Software 202

Second, FIG. 5B will be described. FIG. 5B illustrates an additional settings screen displayed by the general-purpose printing software 202 when the extension printing application 208 is not present. A control 505 is a button that allows for setting a paper type, indicating that “Plain Paper” is selected. A control 506 is a button that allows for specifying a paper size. A control 507 is a button that allows for specifying a paper feed source for a printer. A control 508 is a settings completion button. When the control 508 is pressed, the screen returns to the print-settings screen of FIG. 5A.

### FIG. 5C Advanced-Settings Screen Displayed by Print-Settings-Screen Extension Unit 209

Next, FIG. 5C will be described. FIG. 5C illustrates an additional settings screen displayed by the print-settings-screen extension unit 209 when the extension printing application 208 is present. Unlike FIG. 5B, a control 512 and a list 513 are added. The control 512 is a button that allows for selecting a sharpness setting, indicating that “+1” is selected. When the control 512 is pressed, the list 513 shows setting values for the sharpness setting.

The list 513 indicates that, in addition to the currently selected “+1”, there are setting values for “−1”, “0”, and “+2”. The sharpness setting “0” indicates that no sharpness process is performed. The sharpness setting values “+1” and “+2” are setting values for improving the sharpness. The setting value “+2” improves the sharpness more than the setting value “+1”. The sharpness setting value “−1” is a setting value for decreasing the sharpness of the images. The user switches the sharpness function to perform printing by selecting a sharpness setting value for a desired image quality from the list 513.

The reason why the print setting items differ between FIG. 5B and FIG. 5C will be described. The advanced-settings screen is generated with reference to capability information generated based on the printing function information 203. However, since the general-purpose printing software 202 does not support the sharpness function, the sharpness function cannot be added to the printing function information 203. Even if the printing function information 203 originally includes the sharpness function, the general-purpose printing software 202 cannot interpret the sharpness function included in the printing function information 203, and therefore cannot display the sharpness setting on the advanced-settings screen.

For this reason, the printing-function extension unit 211 is configured to add the sharpness function to the printing function information 203 so that the print-settings-screen extension unit 209 can display the advanced-settings screen with reference to the print capabilities. This configuration enables the extension printing application 208 to display the sharpness setting on the advanced-settings screen. FIG. 5C may additionally include extended functions other than the sharpness function.

### Examples of FAX-Settings Screen/Advanced-Settings Screen

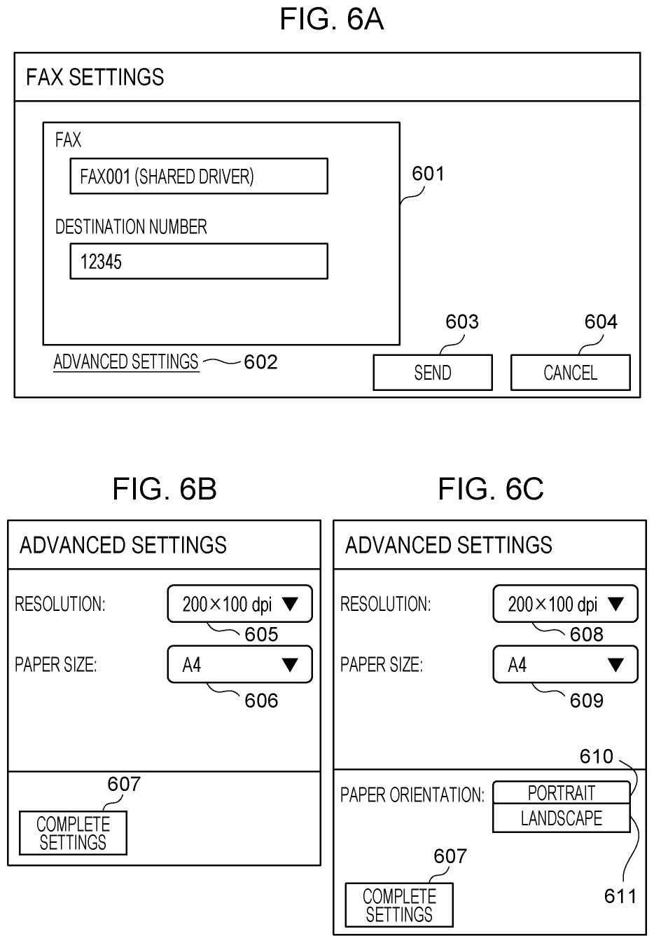

Next, examples of the FAX-settings screen and the advanced-settings screen according to this embodiment will be described with reference to FIGS. 6A to 6C. FIG. 6A illustrates a FAX-settings screen displayed by the application 201. FIG. 6B illustrates an advanced-settings screen displayed when the extension FAX application 220 illustrated in FIG. 2A is not present. FIG. 6C illustrates an advanced-settings screen when the extension FAX application 220 illustrated in FIG. 2B is present.

The units and modules for displaying the FAX-settings screens are not limited to the above. For example, the FAX-settings-screen extension unit 221 may only generate a display screen. In this case, the FAX-settings-screen extension unit 221 sends the generated display screen to the application 201 via the general-purpose FAX software 206. The application 201 may be configured to display the obtained display screen.

### FIG. 6A FAX-Settings Screen Displayed by Application 201

First, FIG. 6A will be described. A control 601 includes objects to prompt the user to set a facsimile (a printer to be used to send a fax), which is the destination of the image data, and destination number. A control 603 is a transmission-start (send) button. A control 604 is a transmission cancel button. A control 602 is an advanced settings button. When the control 602 is pressed, an additional FAX screen is displayed by the general-purpose FAX software 206 or the FAX-settings-screen extension unit 221.

### FIG. 6B Advanced-Settings Screen Displayed by General-Purpose FAX Software 206

Second, FIG. 6B will be described. FIG. 6B illustrates an additional settings screen displayed by the general-purpose FAX software 206 when the extension FAX application 220 is not present. A control 605 is a button that allows for setting a transmission resolution, indicating that “200×100 dpi” is selected. A control 606 allows for setting a paper size. A control 607 is a complete-settings button. When the control 607 is pressed, the screen returns to the FAX-settings screen of FIG. 6A.

### FIG. 6C Advanced-Settings Screen Displayed by FAX-Settings-Screen Extension Unit 221

Next, FIG. 6C will be described. FIG. 6C illustrates an additional settings screen displayed by the FAX-settings-screen extension unit 221 when the extension FAX application 220 is present. Unlike FIG. 6B, a control 610 and a list 611 are added. The control 610 is a button that allows for selecting a paper-orientation setting, indicating that “Portrait” is selected. When the control 610 is pressed, the list 611 shows setting items for the paper-orientation setting.

The list 611 indicates that, in addition to the currently selected “Portrait”, there is a setting value for “Landscape”.

The user switches the paper-orientation function to send a fax by selecting the paper-orientation setting value for a desired image orientation from the list 611.

The reason why the FAX setting items differ between FIG. 6B and FIG. 6C will be described. The advanced-settings screen is generated with reference to FAX capabilities generated based on the FAX function information 207.

However, since the general-purpose FAX software 206 does not support the paper-orientation function, the paper-orientation function cannot be added to the FAX function information 207. Even if the FAX function information 207 originally includes the paper-orientation function, the general-purpose FAX software 206 cannot interpret the paper-orientation function included in the FAX function information 207, and therefore cannot display the paper-orientation setting on the advanced-settings screen.

For this reason, the FAX-function extension unit 223 is configured to add the paper-orientation function to the FAX function information 207 so that the FAX-settings-screen extension unit 221 can display the advanced-settings screen with reference to the FAX capabilities. This configuration enables the extension FAX application 220 to display the paper orientation setting on the advanced-settings screen. FIG. 6C may additionally include extended functions other than the paper orientation function. For example, the sharpness function, described above, and a masking function for concealing private information, etc. by painting black or the like may be set.

### Sequence after Application 201 Accepted Scan Settings

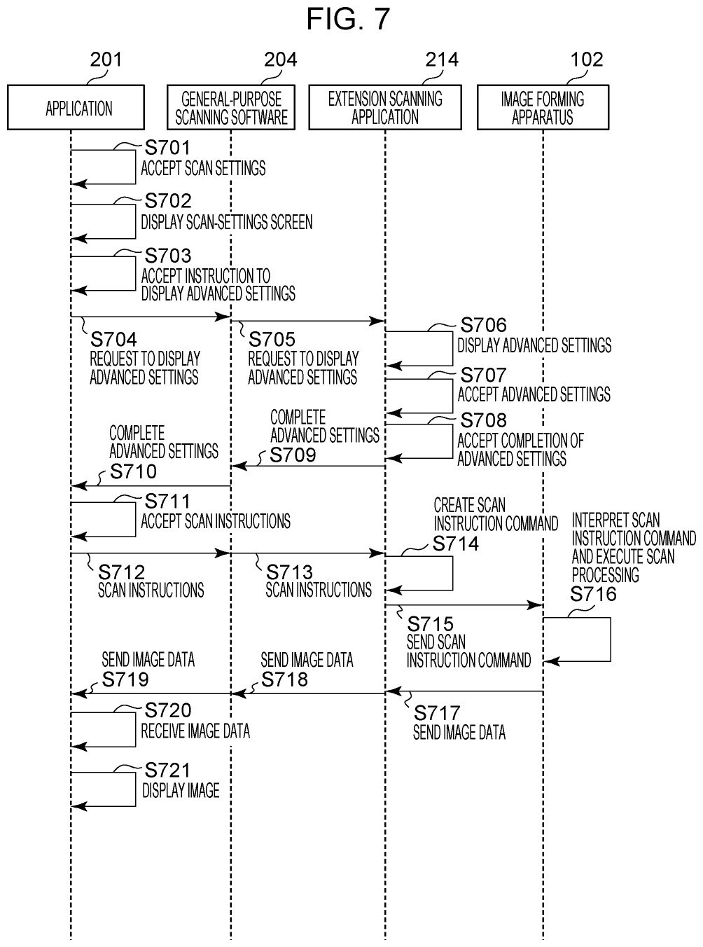

Next, the sequence of operations of the application 201, the general-purpose scanning software 204, the extension scanning application 214, and the image forming apparatus 102 after the application 201 has accepted scan setting values will be described with reference to FIG. 7.

The steps other than the steps of the image forming apparatus 102 in FIG. 7 are implemented by the CPU 111 reading the application 201, the general-purpose scanning software 204, and the extension scanning application 214 from the external storage 114 into the RAM 113 and executing them. The steps of the image forming apparatus 102 in FIG. 7 are implemented by the CPU 191 of the image forming apparatus 102 reading programs that are stored in the ROM 192 or the external storage 199 into the RAM 193 and executing them.

First, in S701, the application 201 accepts scan setting values from the user. The user can instruct the application 201 to configure scan settings by operating the pointing device 117 or the keyboard 118.

Second, in S702, the application 201 displays the scan-settings screen illustrated in FIG. 4A on the display unit 119.

Next, in S703, the application 201 accepts an instruction to display an advanced settings screen. The user can provide the instruction to display the advanced settings screen by operating the pointing device 117 or the keyboard 118 to select the control 402.

In S704, the application 201 requests the general-purpose scanning software 204 to display advanced settings.

In S705, the general-purpose scanning software 204 requests the extension scanning application 214 to display the advanced settings. In the case of the configuration of FIG. 2A, the general-purpose scanning software 204 displays the advanced-settings screen of FIG. 4B, as described above.

In S706, the scan-settings-screen extension unit 215 of the extension scanning application 214 displays the advanced-settings screen of FIG. 4C on the display unit 119. The scan-settings-screen extension unit 215 displays the advanced-settings screen of FIG. 4C on the display unit 119 with reference to the scan capabilities generated based on the scanning function information 205 after the addition.

In S707, the scan-settings-screen extension unit 215 accepts the advanced setting values. In this embodiment, “Scan Source: Platen Glass” and “Scan Size: A4H” are selected by the user, as illustrated in FIG. 4C. The accepted setting values are stored in the RAM 113 by the CPU 111.

Next, in S708, the scan-settings-screen extension unit 215 accepts completion of the advanced settings and writes the accepted setting values into the scan settings information. The user can provide an instruction to terminate the advanced settings by operating the pointing device 117 or the keyboard 118 to select the control 406. Items that are not selected by the user, such as the resolution, may be written together when the scan setting values are written to the scan settings information.

In S709, the extension scanning application 214 sends completion of the advanced settings to the general-purpose scanning software 204.

In S710, the general-purpose scanning software 204 sends the completion of the advanced settings to the application 201.

In S711, the application 201 accepts scan instructions. The user can provide the scan instructions by selecting the control 403 with the pointing device 117 or the keyboard 118.

In S712, the application 201 provides the scan instructions to the general-purpose scanning software 204. Next, in S713, the general-purpose scanning software 204 provides the scan instructions to the extension scanning application 214.

In S714, the extension scanning application 214 creates a scan instruction command based on the scan settings information written in S708. Next, in S715, the extension scanning application 214 sends the scan instruction command to the image forming apparatus 102 to initiate scanning. The transmission of the scan instruction command to the image forming apparatus 102 may be performed via the general-purpose scanning software 204 or the OS.

In S716, the image forming apparatus 102 interprets the scan instruction command and executes a scan. During execution of the scan, necessary image processing according to the scan instructions is performed on the image data. In this embodiment, if the scan setting values in FIG. 4C have been configured, scanning is performed at the specified size. In other words, an A4-size portrait image is generated.

In S717, the image forming apparatus 102 sends the generated image data to the extension scanning application 214. In S718, the extension scanning application 214 sends the received image data to the general-purpose scanning software 204. In S719, the general-purpose scanning software 204 sends the received image data to the application 201. In S720, the application 201 receives the image data. In S721, the application 201 displays the received image data.

Sequence after Application 201 Accepted Print Settings

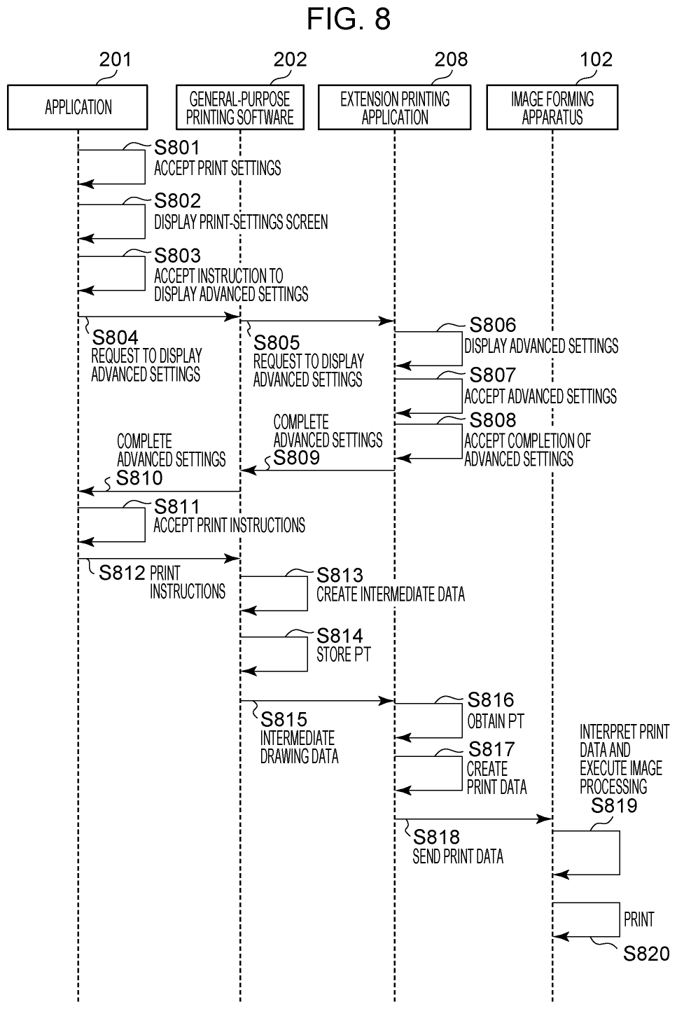

Next, the sequence of operations of the application 201, the general-purpose printing software 202, the extension printing application 208, and the image forming apparatus 102 after the application 201 has accepted print setting values will be described with reference to FIG. 8.

The steps other than the steps of the image forming apparatus 102 in FIG. 8 are implemented by the CPU 111 reading the application 201, the general-purpose printing software 202, and the extension printing application 208 from the external storage 114 into the RAM 113 and executing them. The steps of the image forming apparatus 102 in FIG. 8 are implemented by the CPU 191 of the image forming apparatus 102 reading programs that are stored in the ROM 192 or the external storage 199 into the RAM 193 and executing them.

First, in S801, the application 201 accepts print setting values from the user.

The user can instruct the application 201 to configure print settings by operating the pointing device 117 or the keyboard 118. Second, in S802, the application 201 displays the print-settings screen illustrated in FIG. 5A on the display unit 119.

Next, in S803, the application 201 accepts an instruction to display an advanced settings screen. The user can provide the instruction to display the advanced settings screen by operating the pointing device 117 or the keyboard 118 to select the control 502.

In S804, the application 201 requests the general-purpose printing software 202 to display advanced settings. In S805, the general-purpose printing software 202 requests the extension printing application 208 to display the advanced settings. In the case of the configuration of FIG. 2A, the general-purpose printing software 202 displays the advanced-settings screen of FIG. 5B, as described above.

In S806, the print-settings-screen extension unit 209 of the extension printing application 208 displays the advanced-settings screen of FIG. 5C on the display unit 119.

In S807, the print-settings-screen extension unit 209 accepts the advanced setting values. In this embodiment, “Paper Type: Plain Paper”, “Paper Size: A4”, “Paper Feed Source: Automatic”, and “Sharpness: +1” are selected by the user, as illustrated in FIG. 5C. The accepted setting values are stored in the RAM 113 by the CPU 111.

Next, in S808, the print-settings-screen extension unit 209 accepts completion of the advanced settings and provides an instruction to write the accepted setting values into PT. The user can provide an instruction to terminate the advanced settings by operating the pointing device 117 or the keyboard 118 to select the control 508.

In S809, the extension printing application 208 sends completion of the advanced settings to the general-purpose printing software 202. In S810, the general-purpose printing software 202 sends the completion of the advanced settings to the application 201.

In S811, the application 201 accepts print instructions. The user can provide the print instructions by selecting the control 503 with the pointing device 117 or the keyboard 118. In S812, the application 201 provides the print instructions.

Next, in S813, the general-purpose printing software 202 generates intermediate data using an OS module.

Next, in S814, the general-purpose printing software 202 stores the PT in the shared information 213. The general-purpose printing software 202 converts the content of the PT to the setting value of IPP data to generate IPP data.

In S815, the general-purpose printing software 202 passes the intermediate data and the converted IPP data to the extension printing application 208.

In S816, the intermediate-data editing unit 210 of the extension printing application 208 obtains the PT stored in S814 from the shared information 208.

Next, in S817, the intermediate-data editing unit 210 of the extension printing application 208 imparts the item name of the sharpness and its setting value to the extended area of the IPP data. The intermediate-data editing unit 210 of the extension printing application 208 generates print data from the intermediate data. Next, in S818, the intermediate-data editing unit 210 of the extension printing application 208 sends the print data to the image forming apparatus 102.

In S819, the image forming apparatus 102 interprets the print data and performs necessary image processing on the image in the print data. In this embodiment, if the print setting values in FIG. 5C are configured, image processing for “sharpness: +1” is performed. In other words, image data with higher sharpness than that when no sharpness processing is performed is generated.

In S820, the image forming apparatus 102 prints the image data generated in S819.

### Sequence after Application 201 Accepted FAX Settings

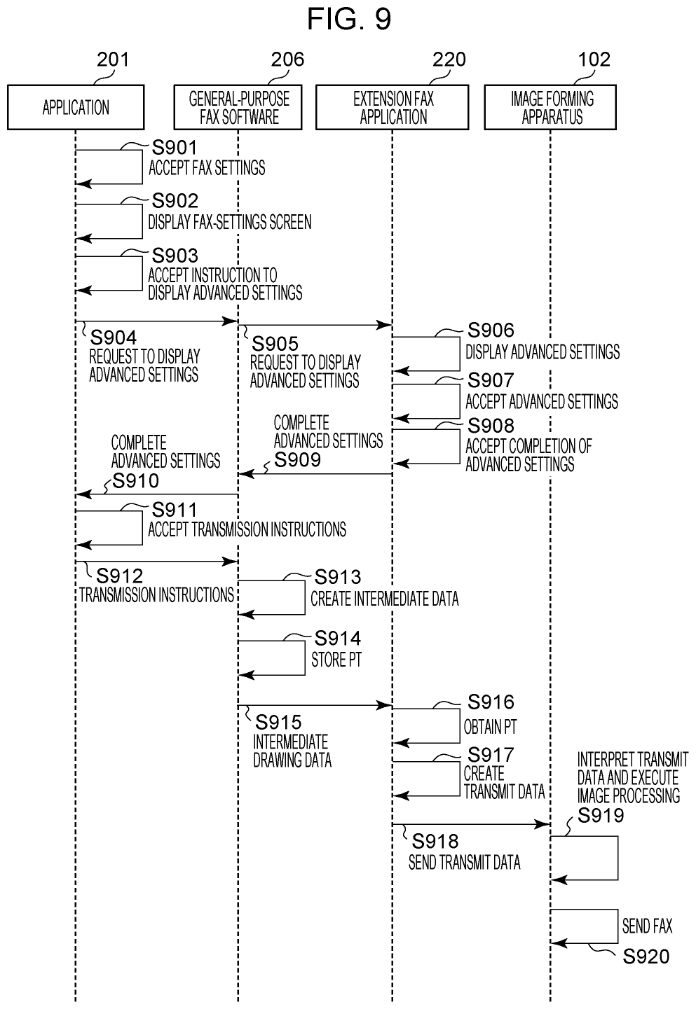

Next, the sequence of operations of the application 201, the general-purpose FAX software 206, the extension FAX application 220, and the image forming apparatus 102 after the application 201 has accepted FAX setting values will be described with reference to FIG. 9.

The steps other than the steps of the image forming apparatus 102 in FIG. 9 are implemented by the CPU 111 reading the application 201, the general-purpose FAX software 206, and the extension FAX application 220 from the external storage 114 into the RAM 113 and executing them. The steps of the image forming apparatus 102 in FIG. 9 are implemented by the CPU 191 of the image forming apparatus 102 reading programs that are stored in the ROM 192 or the external storage 199 into the RAM 193 and executing them.

First, in S901, the application 201 accepts FAX setting values from the user. The user can instruct the application 201 to configure FAX settings by operating the pointing device 117 or the keyboard 118.

Second, in S902, the application 201 displays the FAX-settings screen illustrated in FIG. 6A on the display unit 119.

Next, in S903, the application 201 accepts an instruction to display an advanced settings screen. The user can provide the instruction to display the advanced settings screen by operating the pointing device 117 or the keyboard 118 to select the control 602.

In S904, the application 201 requests the general-purpose FAX software 206 to display advanced settings. In S905, the general-purpose FAX software 206 requests the extension FAX application 220 to display the advanced settings. In the case of the configuration of FIG. 2A, the general-purpose FAX software 206 displays the advanced-settings screen of FIG. 6B, as described above.

In S906, the FAX-settings-screen extension unit 221 of the extension FAX application 220 displays the advanced-settings screen of FIG. 6C on the display unit 119.

In S907, the FAX-settings-screen extension unit 221 accepts the advanced setting values.

In this embodiment, “Resolution: 200×100 dpi”, “Paper Size: A4”, and “Paper Orientation: Portrait” are selected by the user, as illustrated in FIG. 6C. The accepted setting values are stored in the RAM 113 by the CPU 111.

Next, in S908, the FAX-settings-screen extension unit 221 accepts completion of the advanced settings and provides an instruction to write the accepted setting values into PT. The user can provide an instruction to terminate the advanced settings by operating the pointing device 117 or the keyboard 118 to select the control 607.

In S909, the extension FAX application 220 sends completion of the advanced settings to the general-purpose FAX software 206. In S910, the general-purpose FAX software 210 sends the completion of the advanced settings to the application 201.

In S911, the application 201 accepts FAX instructions. The user can provide the FAX instructions by selecting the control 603 with the pointing device 117 or the keyboard 118. In S912, the application 201 provides the FAX instructions. Next, in S913, the general-purpose FAX software 206 generates intermediate data using an OS module.

Next, in S914, the general-purpose FAX software 206 stores the PT in the shared information 225. The general-purpose FAX software 206 converts the content of the PT to the setting value of IPP data to generate IPP data.

In S915, the general-purpose FAX software 206 passes the intermediate data and the converted IPP data to the extension FAX application 220. In S916, the intermediate-data editing unit 222 of the extension FAX application 220 obtains the PT stored in S914 from the shared information 225. Next, in S917, the intermediate-data editing unit 222 of the extension FAX application 220 imparts the item name of the paper orientation and its setting value to the extended area of the IPP data. The intermediate-data editing unit 222 of the extension FAX application 220 generates transmit data from the intermediate data.

Next, in S918, the intermediate-data editing unit 222 of the extension FAX application 220 sends the transmit data to the image forming apparatus 102. In S919, the image forming apparatus 102 interprets the transmit data and performs necessary image processing on the image in the transmit data. In this embodiment, if the FAX settings in FIG. 6C are configured, image processing for “Paper Orientation: Portrait” is performed. In other words, image data in which the image is rotated to match “Paper Orientation: Portrait” is generated. In S920, the image forming apparatus 102 sends the transmit data generated in S919 to the destination.

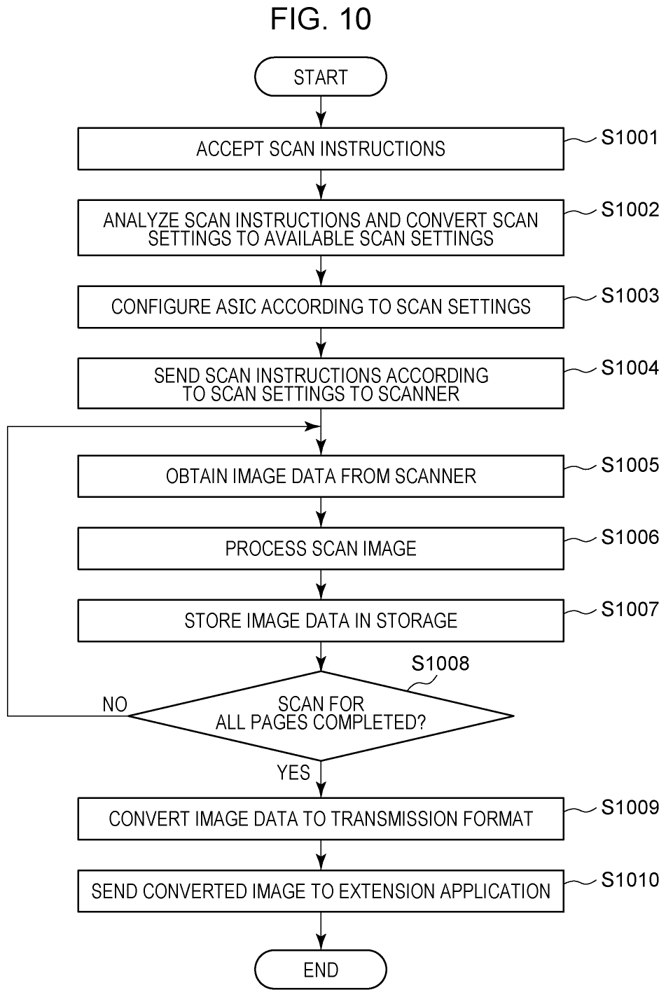

Next, the processing flow of the scanning operation in the image forming apparatus 102 that has received scan instructions from the extension scanning application 214 will be described with reference to FIG. 10. The operations (steps) illustrated in the flowchart of FIG. 10 are implemented by the CPU 191 executing programs stored in the RAM 193.

First, in step S1001, the CPU 191 accepts scan instructions sent from the extension scanning application 214.

Second, in step S1002, the CPU 191 analyzes the scan instruction command accepted in step S1001 and converts the scan setting values to scan setting values with which the image forming apparatus 102 can perform scan processing. In this embodiment, the scan setting values are “Platen Glass” and “Scan Size: A4H”. Next, in step S1003, the CPU 191 determines an application specific integrated circuit (ASIC) for the image processing unit 190 to be used to execute the scanning according to the scan setting values converted in step S1002 and configures the ASIC.

In step S1004, the CPU 191 sends scan instructions according to the scan setting values to the reading unit 195. In this embodiment, the CPU 191 sends instructions to perform scanning on the platen glass, with “Scan Size: A4H”.

In step S1005, the CPU 191 obtains image data from the reading unit 195. In this embodiment, the CPU 191 obtains A4H-size image data. In S1006, the CPU 191 and the image processing unit 190 execute image processing on the received image data. In S1007, the CPU 191 stores the image data in the external storage 199.

In step S1008, the CPU 191 determines whether the scan processing for all pages has been completed. If the CPU 191 determines that the scan processing for all pages has not been completed, the CPU 191 returns to S1005 and executes the scan processing for the next page. If the CPU 191 determines that the scan processing for all pages has been completed, the CPU 191 proceeds to S1009.

In step S1009, the CPU 191 and the image processing unit 190 convert the image data stored in step S1007 according to the transmission format settings accepted in step S701. In this embodiment, no transmission format is included in the scan instructions accepted from the extension scanning application 214. For this reason, the image data is converted to the default joint photographic experts group (JPEG) of the image forming apparatus 102. However, the transmission format for conversion is not limited to this; any format that can be supported by the information processing apparatus is acceptable.

In step S1010, the converted image data is sent to the extension scanning application 214, and all the processes end.

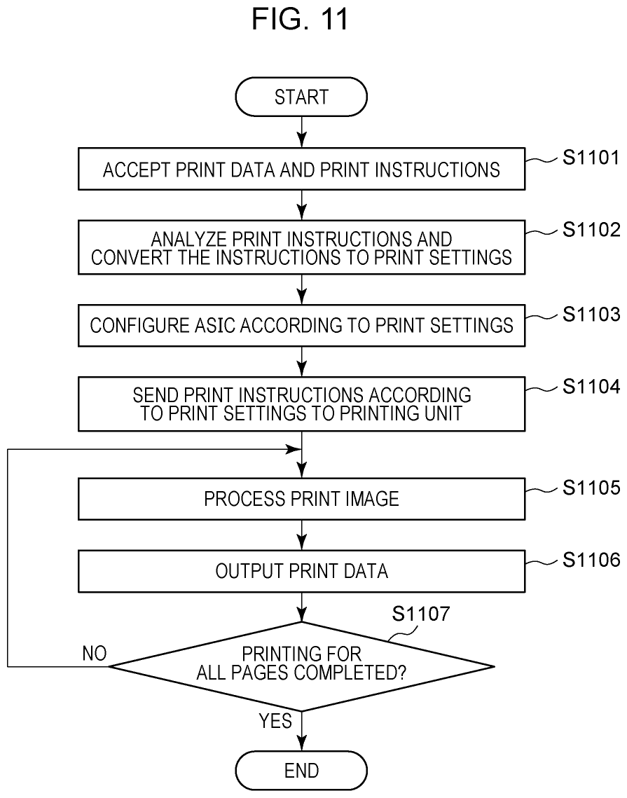

Next, the processing flow of the printing operation in the image forming apparatus 102 that has received print instructions from the extension printing application 208 will be described with reference to FIG. 11. The operations (steps) illustrated in the flowchart of FIG. 11 are implemented by the CPU 191 executing programs stored in the RAM 193.

In step S1101, the CPU 191 accepts print data and print instructions sent from the extension printing application 208.

Second, in step S1102, the CPU 191 analyzes the print instruction command accepted in step S1101 and converts the print setting values to print setting values with which the image forming apparatus 102 can perform print processing. In this embodiment, the print setting values are “Paper Type: Plain Paper”, “Paper Size: A4”, “Paper Feed Source: Automatic”, and “Sharpness: +1”.

Next, in step S1103, the CPU 191 determines an ASIC for the image processing unit 190 to be used to execute the printing according to the print setting values converted in step S1102 and configures the ASIC.

In step S1104, the CPU 191 sends print instructions according to the print setting values to the printing unit 196. In this embodiment, the CPU 191 sends instructions where “Paper Type: Plain Paper” and “Paper Size: A4” are set, to automatically select the paper feed source for printing.

In step S1105, the CPU 191 and the image processing unit 190 execute image processing on the received print data. In this embodiment, the CPU 191 and the image processing unit 190 perform image processing with “Sharpness: +1”. If the print data has already been subjected to image processing for sharpness, the image processing in step S1105 may be omitted.

In step S1106, the CPU 191 outputs the print data to the printing unit 196. In step S1107, the CPU 191 determines whether the print processing for all pages has been completed.

If the CPU 191 determines that the print processing for all pages has not been completed, the CPU 191 returns to S1105 and executes the print processing for the next page. If the CPU 191 determines that the print processing for all pages has been completed, the CPU 191 terminates all the processes.

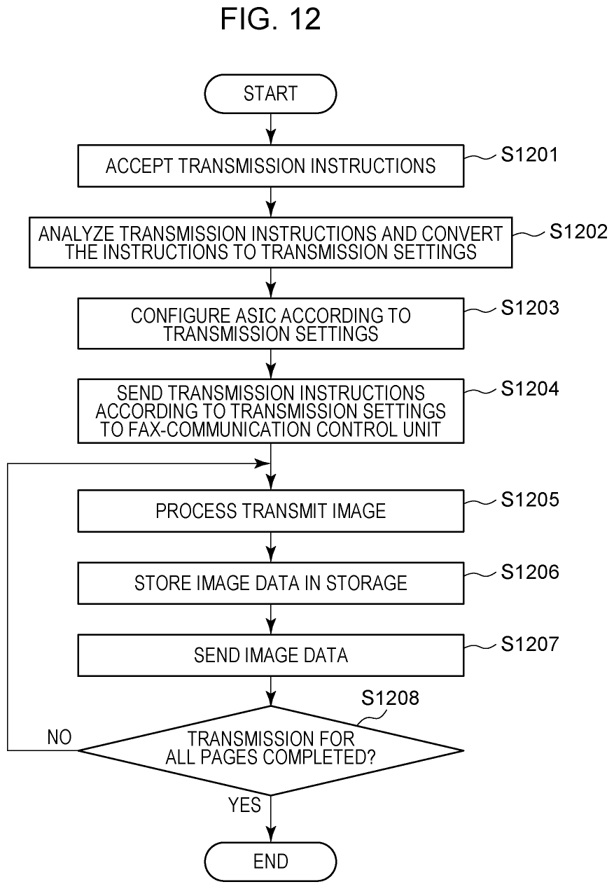

Next, the processing flow of the FAX operation in the image forming apparatus 102 that has received FAX instructions from the extension FAX application 220 will be described with reference to FIG. 12. The operations (steps) illustrated in the flowchart of FIG. 12 are implemented by the CPU 191 executing programs stored in the RAM 193.

First, in step S1201, the CPU 191 accepts FAX transmit data and FAX transmission instructions sent from the extension FAX application 220.

Second, in step S1202, the CPU 191 analyzes the FAX instruction command accepted in step S1201 and converts the FAX setting values to FAX setting values with which the image forming apparatus 102 can perform FAX processing. In this embodiment, the FAX setting values are “Resolution: 200×100 dpi”, “Paper Size: A4”, and “Paper Orientation: Portrait”.

Next, in step S1203, the CPU 191 determines an ASIC for the image processing unit 190 to be used to execute the FAX according to the FAX setting values converted in step S1202 and configures the ASIC.

In step S1204, the CPU 191 sends FAX instructions according to the FAX setting values to the FAX-communication control unit 180. In this embodiment, the CPU 191 sends instructions to send a fax to the destination number 12345.

In step S1205, the CPU 191 and the image processing unit 190 execute image processing on the received transmit data. In this embodiment, the CPU 191 and the image processing unit 190 perform image processing, including resolution conversion to 200×100 dpi and rotation to match “Paper Orientation: Portrait”. If the transmit data has already been subjected to image processing for resolution conversion and rotation, image processing in step S1205 may be omitted.

In step S1206, the CPU 191 stores the image data in the external storage 199. In step S1207, the FAX-communication control unit 180 sends the image data stored in step S1206 to the destination. In step S1208, the CPU 191 determines whether the transmission processing for all pages has been completed. If the CPU 191 determines that the transmission processing for all pages has not been completed, then the CPU 191 returns to S1205 and executes the transmission processing for the next page. If the CPU 191 determines that the transmission processing for all pages has been completed, the CPU 191 terminates all the processes.

As described above, in this embodiment, the general-purpose printing software 202, the general-purpose scanning software 204, and the general-purpose FAX software 206 are invoked from the application 201. Furthermore, the extension printing application 208 is invoked from the general-purpose printing software 202, the extension scanning application 214 is invoked from the general-purpose scanning software 204, and the extension FAX application 220 is invoked from the general-purpose FAX software 206. Through the above series of processes, printing, scanning, and FAX functions can be provided to the user with the same application.

### Second Embodiment

A second embodiment of the present disclosure will be described hereinbelow. In the first embodiment, when a FAX function is provided, a settings screen only for FAX is displayed by the application 201. In the second embodiment, a configuration is described in which the application 201 displays a print-settings screen, and when FAX software is selected for a printer, an extension FAX application is displayed by the general-purpose printing software 202. Only the difference from the first embodiment will be described hereinbelow.

### System Configuration Centered on Software

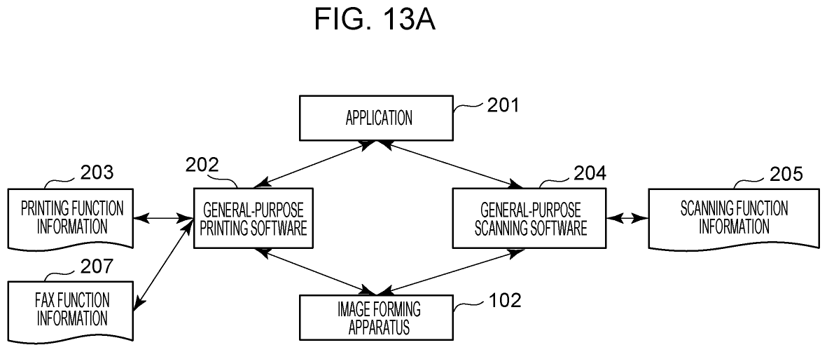

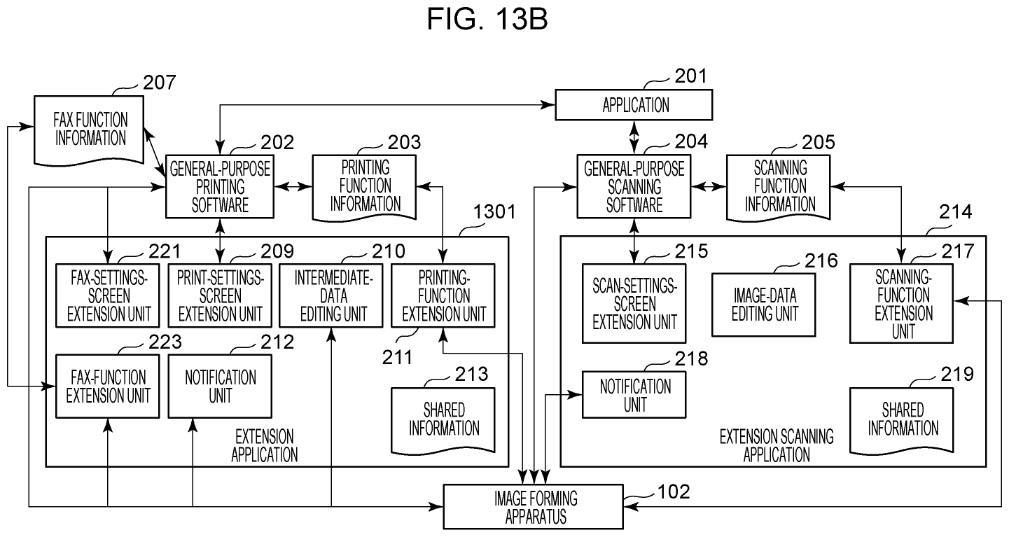

FIGS. 13A and 13B schematically illustrate the software configuration of the system according to the second embodiment. The software configuration in FIGS. 13A and 13B is stored in the external storage 114 of FIG. 1. Here, the explanation is based on a system that uses the host computer 101 equipped with Microsoft® Windows® 11 as its OS.

FIG. 13A is a diagram illustrating a general configuration in which an extension application 1301 and the extension scanning application 214 are not associated with the general-purpose software 202 and 204 and the image forming apparatus 102. FIG. 13B is a diagram illustrating a configuration in which the extension application 1301 and the extension scanning application 214 are associated with the general-purpose software 202 and 204 and the image forming apparatus 102.

System Configuration Centered on Software (when Extension Application 1301 and Extension Scanning Application 214 are not Associated)

First, the configuration of the system in the case where the extension application 1301 and the extension scanning application 214 are not associated will be described with reference to FIG. 13A.

The application 201 is software that allows multiple functions of the image forming apparatus, such as printing, scanning, and FAX, to be used. In response to a request from the user, the application 201 issues instructions to the OS. For example, scan instructions include scan settings information for specifying the operations of the general-purpose scanning software 204 and the image forming apparatus 102.

In this configuration, the general-purpose software is invoked from the native application. This is however illustrative only. The general-purpose software may be invoked from a web application or web site on the Internet or may be operated as part of an integrated system.

In this embodiment, the configuration file of the general-purpose printing software 202 includes FAX function information 207 in addition to the printing function information 203. This allows the application 201 to display a FAX-settings screen provided by the general-purpose printing software 202, OS, or the application 201 to execute FAX instruction.

When an advanced settings button in the FAX-settings screen is pressed, the general-purpose printing software 202 additionally displays an advanced-settings screen. The FAX function information 207 is included in the configuration file of the general-purpose printing software 202 and is saved in the external storage 114 as an unchangeable file.

Also, the FAX function information 207 may be dynamically generated by the general-purpose printing software 202. Specifically, the general-purpose printing software 202 or the OS may be configured to obtain the attribute data of the image forming apparatus 102 from the image forming apparatus 102 and generate the FAX function information 207 according to the attribute information in the obtained attribute data. The FAX function information 207, if dynamically generated, can be edited.

The attribute data of the image forming apparatus 102 obtained from the image forming apparatus 102 includes attribute information indicating functions that can be specified by the image forming apparatus 102 (the capabilities of the FAX device) and setting values related to the attribute information. This information is stored in the RAM 113.

This configuration of the general-purpose software 202 and 204 allows the user to specify functions available across all the image forming apparatuses 102 according to the connected image forming apparatus 102. In other words, even if an image forming apparatus with different functions or an image forming apparatus developed by a different vendor (or manufacturer) is connected, the general-purpose software 202 and 204 allows the user to specify available functions according to the connected image forming apparatus 102.

System Configuration Centered on Software (when Extension Applications 1301 and 214 are Associated)

First, the configuration of the system in the case where the extension applications 1301 and 214 are associated will be described with reference to FIG. 13B. Unless otherwise specified below, the components and processes are the same as those of FIG. 13A.

The extension application 1301 is software for extending the functions of the general-purpose printing software 202 and is not contained (packed) in advance in the OS. For this reason, the user needs to operate the host computer 101 to download the extension application 1301 from the server via the Internet and install it.

Also, the extension application 1301 may be automatically installed in response to the connection of the image forming apparatus 102 to the host computer 101. Specifically, when the image forming apparatus 102 is connected to the host computer 101, the OS obtains device identification information from the image forming apparatus 102. The OS may download the extension application 1301 corresponding to the obtained device identification information from the server via the Internet, and install it. In other words, the general-purpose printing software 202 and the extension application 1301 are stored in the host computer 101 as different files.

The general-purpose printing software 202 and the extension application 1301 may be updated and version-upgraded. These update processes are carried out at separate times.

In other words, the timing when the general-purpose printing software 202 is obtained and the timing when the extension application 1301 is obtained by the host computer 101 are different.

The trigger to obtain the general-purpose printing software 202 and the trigger to obtain the extension application 1301 by the host computer 101 are also different. When the extension application 1301 is installed, the OS associates the extension application 1301 with the general-purpose printing software 202 and the image forming apparatus 102.

The extension application 1301 described in this embodiment includes a print-settings-screen extension unit 209, a printing-function extension unit 211, an intermediate-data editing unit 210, a notification unit 212, a FAX-settings-screen extension unit 221, and a FAX-function extension unit 223.

The extension application 1301 further includes shared information 213 accessible from each unit. The actual form of the shared information 213 is a file stored in the external storage 114 or information stored on the RAM 113. The extension application 1301 writes and reads information to/from the shared information 213 by using an application program interface (API) provided by the OS.

The extension application 1301 may terminate the operation every time the process of each unit is completed. In that case, the OS starts the extension application 1301 every time a request to use the unit is provided.

Furthermore, the extension application 1301 may cancel the process of each unit during the process. If the process is cancelled, the job being processed is deleted by the OS.

In response to receiving a print request from the user, the application 201 issues transmission instructions to the OS. In this configuration as well, the application 201 can display a print-settings screen, as with the configuration of FIG. 13A.

In this configuration, an advanced-settings screen provided by the extension application 1301 is displayed.

Specifically, an advanced-settings screen provided by the print-settings-screen extension unit 209 or the FAX-settings-screen extension unit 221 of the extension application 1301 is displayed. The advanced-settings screen to be displayed depends on the printer selected on the print-settings screen. The print-settings-screen extension unit 209 and the FAX-settings-screen extension unit 221 can store advanced setting values set by the user in the shared information 213.

The extension application 1301 includes the intermediate-data editing unit 210. The intermediate-data editing unit 210 obtains intermediate data from the general-purpose printing software 202 and edits the intermediate data. The intermediate-data editing unit 210 converts the intermediate data to print data and thereafter passes the print data to the image forming apparatus 102. The intermediate-data editing unit 210 obtains advanced settings information from the shared information 213 and adds the advanced setting values to the print data. The image forming apparatus 102 prints on the paper surface or sends a fax based on the received print data.

A method for converting the intermediate data to print data is not limited to the above method. The extension application 1301 may obtain print data generated by the general-purpose printing software 202 and add advanced setting values to the print data. The conversion from the intermediate data to print data may be performed by the general-purpose printing software 202. In the configuration of FIG. 13B as well, the general-purpose printing software 202 may pass the print data to the image forming apparatus 102 without passing through the extension application 1301, as in the configuration of FIG. 13A.

The extension application 1301 includes the printing-function extension unit 211. The printing-function extension unit 211 can edit the printing function information 203 generated by the general-purpose printing software 202 or the OS. This allows the printing-function extension unit 211 to add functions to be provided by the extension application 1301.

The printing-function extension unit 211 can also add a function that is supported by the image forming apparatus 102 but is not supported by the general-purpose printing software 202, the exclusion relationship among the setting values of the printing functions, and so on. When the extension application 1301 is first associated with the image forming apparatus 102 and the general-purpose printing software 202, the OS starts the printing-function extension unit 211. The OS may start the printing-function extension unit 211 when the OS is started or at another time.

The extension application 1301 includes the FAX-function extension unit 223. The FAX-function extension unit 223 can edit the FAX function information 207 generated by the general-purpose printing software 202 or the OS. This allows the FAX-function extension unit 223 to add functions to be provided by the extension application 1301.

The FAX-function extension unit 223 can also add a function that is supported by the image forming apparatus 102 but is not supported by the general-purpose printing software 202, the exclusion relationship among the setting values of the FAX functions, and so on. When the extension application 1301 is first associated with the image forming apparatus 102 and the general-purpose printing software 202, the OS starts the FAX-function extension unit 223. The OS may start the FAX-function extension unit 223 when the OS is started or at another time.

The extension application 1301 includes the notification unit 212. The notification unit 212 can display a notification to the user in response to the occurrence of an error in the image forming apparatus 102.

The configuration of the extension application 1301 for implementing this embodiment is not limited to one that includes all of the above-described functions (units) and may include only some of the functions or additional functions. The extension application 1301 may also be simply referred to as printing software.

The configuration of the system for implementing this embodiment is not limited to one that includes all of the general-purpose printing software 202 and the general-purpose scanning software 204 and may include only some of the functions or additional functions. For example, the system may include only the general-purpose printing software 202 or image transmission software over a network, in addition to the two general-purpose software.

### Examples of Print-Settings Screen/Advanced-Settings Screen According to Second Embodiment

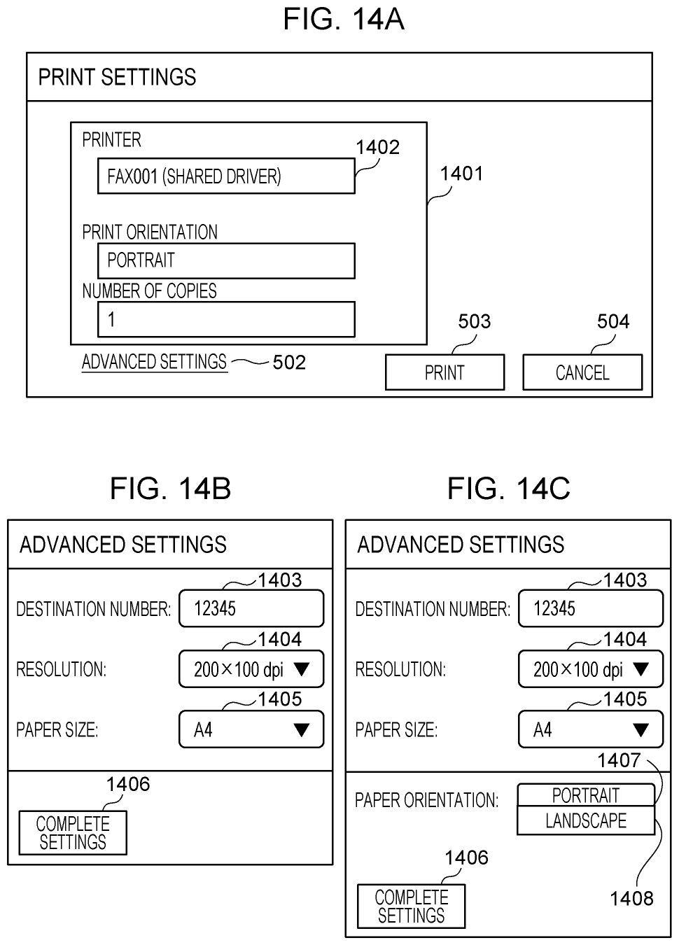

Next, examples of the print-settings screen and the advanced-settings screen according to this embodiment will be described with reference to FIGS. 14A to 14C. FIG. 14A illustrates a print-settings screen displayed by the application 201. FIG. 14B illustrates an advanced-settings screen displayed when the extension application 1301 illustrated in FIG. 13A is not present. FIG. 14C illustrates an advanced-settings screen when the extension application 1301 illustrated in FIG. 13B is present. The units and modules for displaying the print-settings screens are not limited to the above.

### FIG. 14A Print-Settings Screen Displayed by Application 201

First, FIG. 14A will be described. A control 1401 includes objects to prompt the user to set a printer (a printer to be used for printing) that is the destination of the image data, print orientation, and the number of copies. The printer displayed includes a printer for FAX in addition to one for printing. In this embodiment, a FAX printer 1402 is selected.

A control 503 is a print start button. A control 504 is a print cancel button. A control 502 is an advanced settings button. When the control 502 is pressed, an additional print screen is displayed by the general-purpose printing software 202, the print-settings-screen extension unit 209, or the FAX-settings-screen extension unit 221.

### FIG. 14B Advanced-Settings Screen Displayed by General-Purpose Printing Software 202

Second, FIG. 14B will be described. FIG. 14B illustrates an additional settings screen displayed by the general-purpose printing software 202 when a FAX printer is selected, with the extension application 1301 not being present.

A control 1403 is a button that allows for setting a destination number, indicating that “12345” is input in this example. A control 1404 allows for setting a transmission resolution, indicating that “200×100 dpi” is selected in this example. A control 1405 allows for selecting a paper size. A control 1406 is a complete-settings button. When the control 1406 is pressed, the screen returns to the print-settings screen of FIG. 14A.

### FIG. 14C Advanced-Settings Screen Displayed by FAX-Settings-Screen Extension Unit 221

Next, FIG. 14C will be described. FIG. 14C illustrates an additional settings screen displayed by the FAX-settings-screen extension unit 221 when a FAX printer is selected, with the extension application 1301 being present.

Unlike FIG. 14B, a control 1407 and a list 1408 are added. The control 1407 is a button that allows for selecting a paper-orientation setting, indicating that “Portrait” is selected. When the control 1407 is pressed, the list 1408 shows setting items for the paper-orientation setting. The list 1408 indicates that, in addition to the currently selected “Portrait”, there is a setting value for “Landscape”. The user switches the paper-orientation function to send a fax by selecting the paper-orientation-setting value for the desired image orientation from the list 1408.

### Sequence after Application 201 Accepted Print Settings

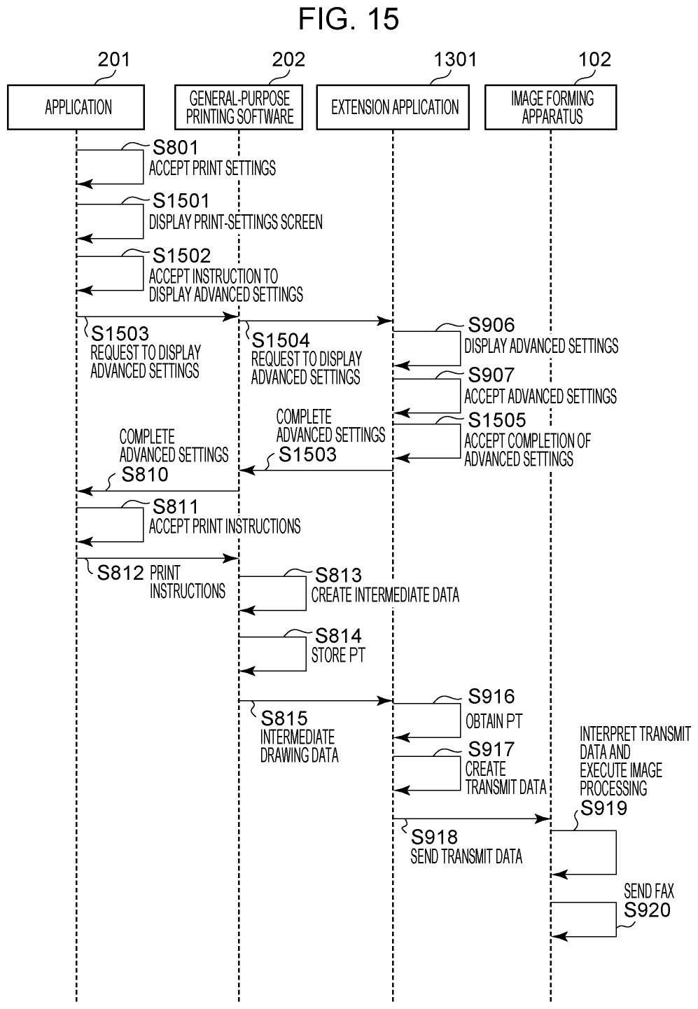

Next, the sequence of operations of the application 201, the general-purpose printing software 202, the extension application 1301, and the image forming apparatus 102 after the application 201 has accepted print setting values will be described with reference to FIG. 15.

The steps other than the steps of the image forming apparatus 102 in FIG. 15 are implemented by the CPU 111 reading the application 201, the general-purpose printing software 202, and the extension application 1301 from the external storage 114 into the RAM 113 and executing them. The steps of the image forming apparatus 102 in FIG. 15 are implemented by the CPU 191 of the image forming apparatus 102 reading programs that are stored in the ROM 192 or the external storage 199 into the RAM 193 and executing them.

In S1501, the application 201 displays the print-settings screen illustrated in FIG. 14A on the display unit 119.

Next, in S1502, the application 201 accepts an instruction to display an advanced settings screen. The user can provide the instruction for the advanced settings by operating the pointing device 117 or the keyboard 118 to select the control 502. In this embodiment, the application 201 accepts the instruction for the advanced settings, with a FAX printer 1402 selected.

In S1503, the application 201 requests the general-purpose printing software 202 to display advanced settings. In this embodiment, the application 201 requests to display advanced settings for FAX. Next, in S1504, the general-purpose printing software 202 requests the extension printing application 208 to display the advanced settings for FAX. In this embodiment, the general-purpose printing software 202 requests to display advanced settings for FAX.

In S906, the FAX-settings-screen extension unit 221 of the extension application 1301 displays the advanced-settings screen of FIG. 14C on the display unit 119.

Next, in S907, the FAX-settings-screen extension unit 221 accepts the advanced setting values.

In this embodiment, “Destination Number: 12345”, “Resolution: 200×100 dpi”, “Paper Size: A4”, and “Paper Orientation: Portrait” are selected by the user, as illustrated in FIG. 14C.

The accepted setting values are stored in the RAM 113 by the CPU 111.

In S1505, the extension application 1301 sends the completion of the advanced settings to the general-purpose printing software 202.

As described above, in this embodiment, the application 201 displays a print-settings screen, and when FAX software is selected for a printer, an extension FAX application is displayed by the general-purpose printing software 202. Through the above series of processes, printing, scanning, and FAX functions can be provided to the user with the same application.

### Third Embodiment

A third embodiment of the present disclosure will be described hereinbelow. In the first embodiment, an extension application is invoked from an application via general-purpose software.

However, applications are generally provided by individual vendors (manufacturers) to improve the convenience of the image forming apparatuses of the vendors. For this reason, in many cases, the image forming apparatuses to be used by the applications are limited to image forming apparatuses developed by the specific vendors, and therefore, it may be sufficient to use only a specific extension application without using general-purpose software.

The third embodiment describes a configuration in which an extension application is directly invoked from an application. Only the difference from the foregoing embodiments will be described hereinbelow.

### System Configuration Centered on Software

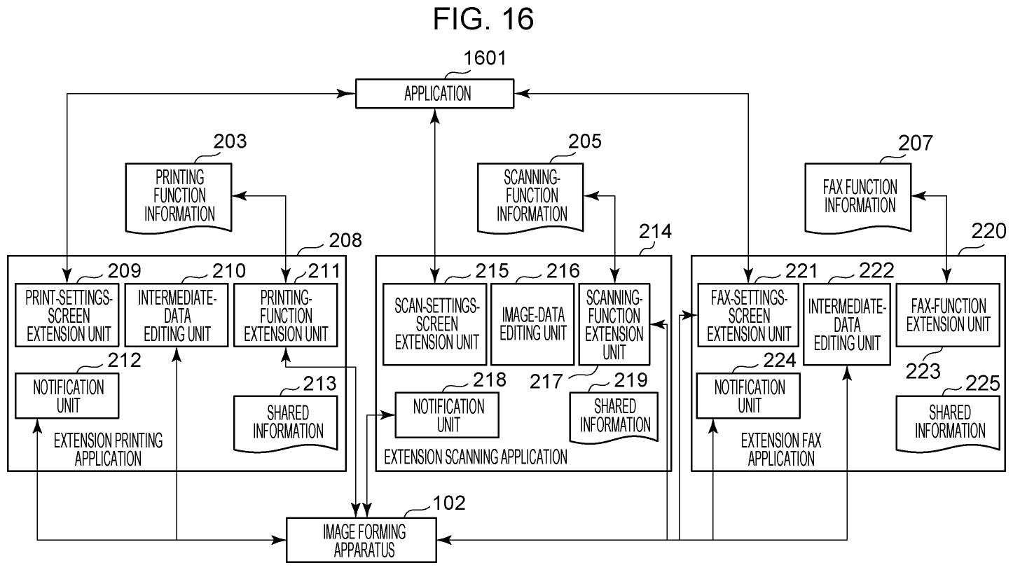

FIG. 16 schematically illustrates the software configuration of the system according to the third embodiment. The software configuration in FIG. 16 is stored in the external storage 114 of FIG. 1. Here, the explanation is based on a system that uses the host computer 101 equipped with Microsoft® Windows® 11 as its OS.

The configuration of the system in the case where an application 1601 and the extension applications 208, 214, and 220 are directly associated will be described with reference to FIG. 16.

The application 1601 is software that allows multiple functions of the image forming apparatus, such as printing, scanning, and FAX, to be used. The application 1601 is associated with the extension applications 208, 214, and 220. In response to a request from the user, the application 1601 directly invokes the extension application 208, 214, or 220. For example, when a scan request is given from the user, the application 1601 invokes the extension scanning application 214.

In this configuration, the extension application 208, 214, or 220 is invoked from the native application. This is however illustrative only. The extension application 208, 214, or 220 may be invoked from a web application or web site on the Internet or may be operated as part of an integrated system.

The application 1601 may store the extension applications 208, 214, and 220 as programs or may invoke a separate program from a file path.

This configuration allows an extension application corresponding to the vendor that provides the application to be easily provided to the user.

### Sequence after Application 1601 Accepted Scan Settings

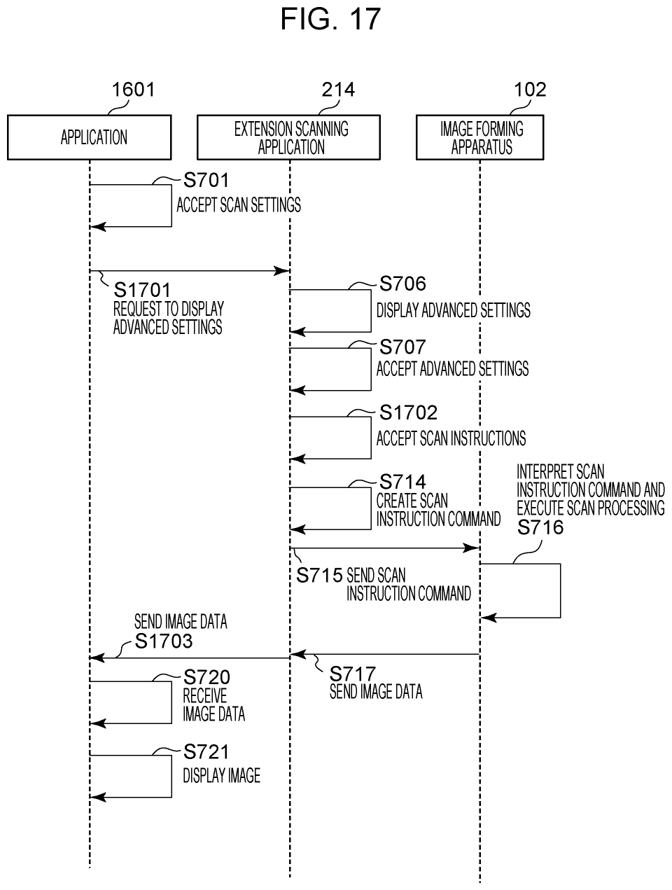

Next, the sequence of operations of the application 1601, the extension scanning application 214, and the image forming apparatus 102 after the application 1601 accepted scan setting values will be described with reference to FIG. 17.

The steps other than the steps of the image forming apparatus 102 in FIG. 17 are implemented by the CPU 111 reading the application 1601 and the extension scanning application 214 from the external storage 114 into the RAM 113 and executing them. The steps of the image forming apparatus 102 in FIG. 17 are implemented by the CPU 191 of the image forming apparatus 102 reading programs that are stored in the ROM 192 or the external storage 199 into the RAM 193 and executing them.

In S1701, the application 1601 requests the extension scanning application 214 to display advanced settings.

In S1702, the extension scanning application 214 accepts scan setting values and writes the accepted setting values into the scan settings information. The user can provide the scan instructions by operating the pointing device 117 or the keyboard 118. In this embodiment, the extension scanning application 214 directly accepts the scan instructions. Also, the application 1601 may accept the instructions and pass the instructions to the extension scanning application 214. In S1703, the extension scanning application 214 sends the received image data to the application 1601.

### Sequence after Application 1601 Accepted Print Settings

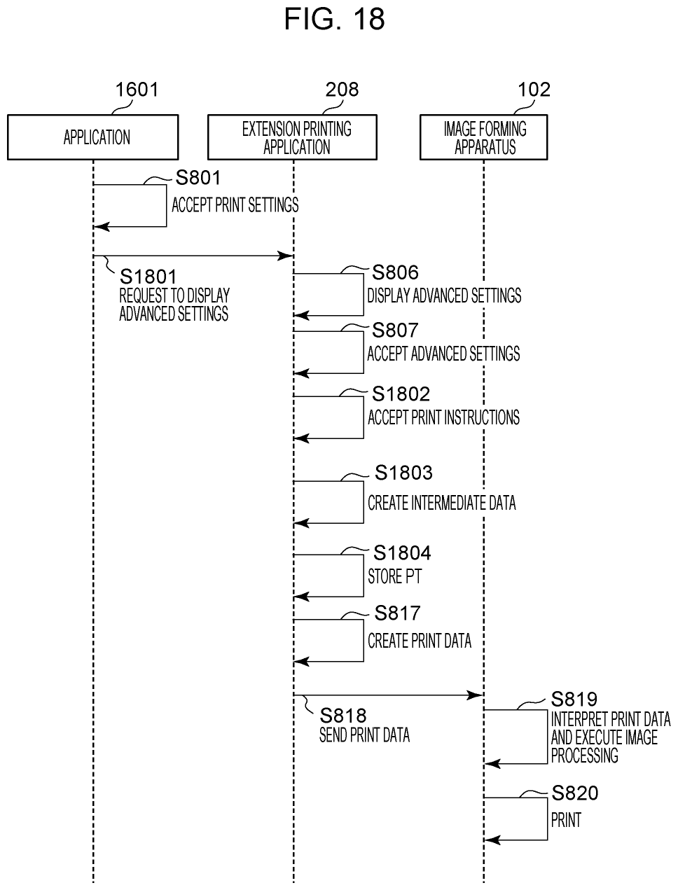

Next, the sequence of operations of the application 1601, the extension printing application 208, and the image forming apparatus 102 after the application 1601 accepted print setting values will be described with reference to FIG. 18.

The steps other than the steps of the image forming apparatus 102 in FIG. 18 are implemented by the CPU 111 reading the application 1601 and the extension printing application 208 from the external storage 114 into the RAM 113 and executing them. The steps of the image forming apparatus 102 in FIG. 18 are implemented by the CPU 191 of the image forming apparatus 102 reading programs that are stored in the ROM 192 or the external storage 199 into the RAM 193 and executing them.

In S1801, the application 1601 requests the extension printing application 208 to display advanced settings.

In S1802, the extension printing application 208 accepts print setting values and writes the accepted setting values into the PT. The user can provide the print instructions by operating the pointing device 117 or the keyboard 118. In this embodiment, the extension printing application 208 directly accepts the print instructions. Also, the application 1601 may accept the instructions and pass the instructions to the extension printing application 208.

In S1803, the extension printing application 208 generates intermediate data using an OS module.

In S1804, the extension printing application 208 stores the PT in the shared information 213. The extension printing application 208 converts the content of the PT to the setting values of IPP data to generate IPP data.

Sequence after Application 1601 Accepted FAX Settings

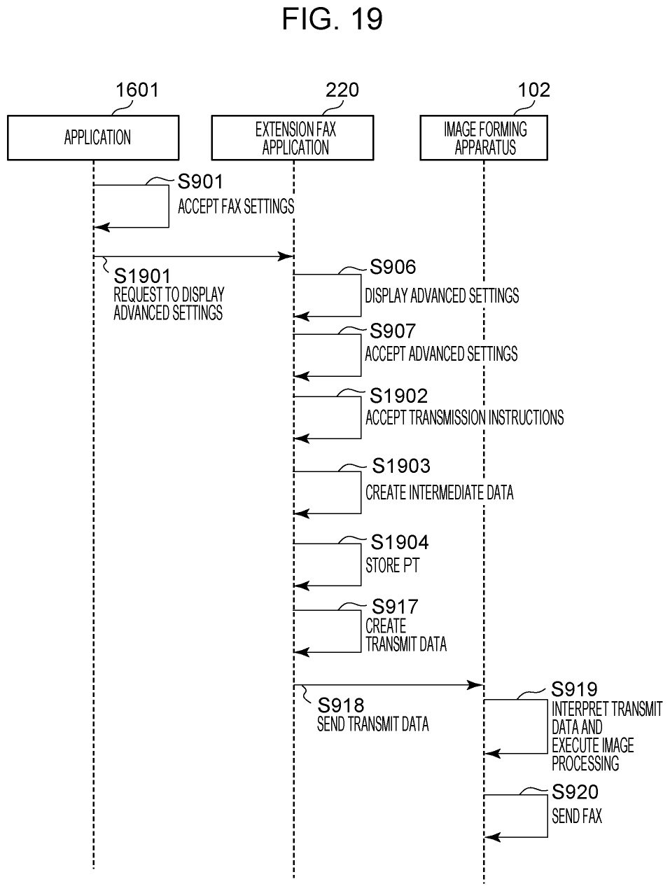

Next, the sequence of operations of the application 1601, the extension FAX application 220, and the image forming apparatus 102 after the application 1601 accepted FAX setting values will be described with reference to FIG. 19.

The steps other than the steps of the image forming apparatus 102 in FIG. 19 are implemented by the CPU 111 reading the application 1601 and the extension FAX application 220 from the external storage 114 into the RAM 113 and executing them. The steps of the image forming apparatus 102 in FIG. 19 are implemented by the CPU 191 of the image forming apparatus 102 reading programs that are stored in the ROM 192 or the external storage 199 into the RAM 193 and executing them.

In S1901, the application 1601 requests the extension FAX application 220 to display advanced settings.

In S1902, the extension FAX application 220 accepts transmission instructions and writes the accepted setting values into the PT. The user can provide the transmission instructions by operating the pointing device 117 or the keyboard 118. In this embodiment, the extension FAX application 220 directly accepts the transmission instructions. Also, the application 1601 may accept the instructions and pass the instructions to the extension FAX application 220.

In S1903, the extension FAX application 220 generates intermediate data using an OS module. In S1904, the extension FAX application 220 stores the PT in the shared information 225. The extension FAX application 220 converts the content of the PT to the setting values of IPP data to generate IPP data.

### Examples of Scan-Settings Screen/Print-Settings Screen/FAX-Settings Screen

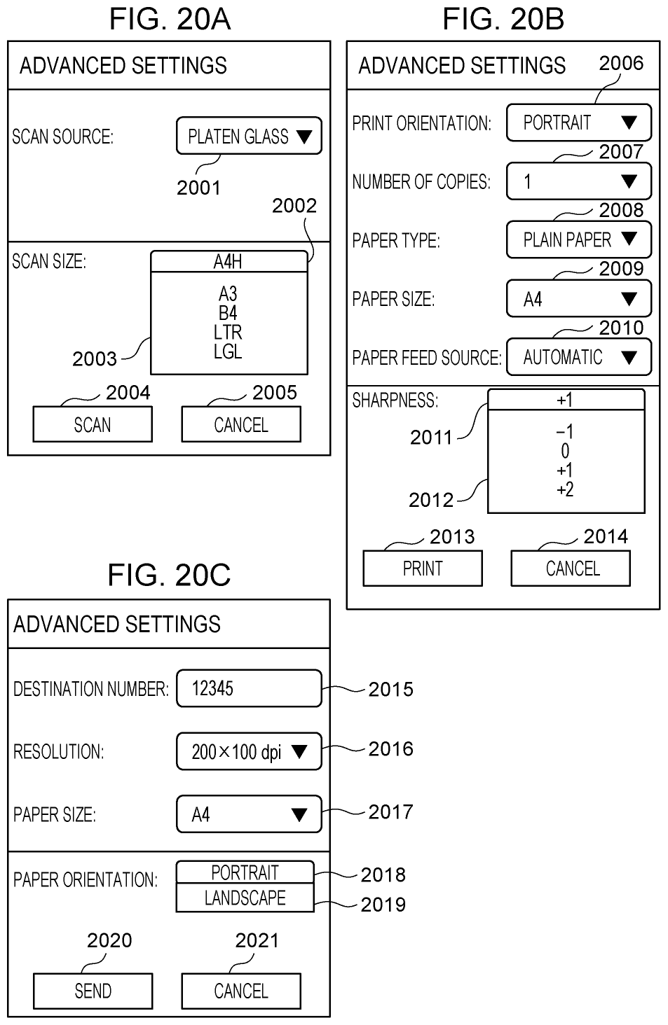

Next, examples of the scan-settings screen, the print-settings screen, and the FAX-settings screen according to this embodiment will be described with reference to FIGS. 20A to 20C. FIG. 20A illustrates a scan-settings screen displayed by the extension scanning application 214. FIG. 20B illustrates a print-settings screen displayed by the extension printing application 208. FIG. 20C illustrates a FAX-settings screen displayed by the extension FAX application 220.

### FIG. 20A Scan-Settings Screen Displayed by Scan-Settings-Screen Extension Unit 215

Next, FIG. 20A will be described. FIG. 20A illustrates a settings screen displayed by the scan-settings-screen extension unit 215. A control 2004 is a scan start button. A control 2005 is a scan cancel button. In this embodiment, the scan start button is displayed on the setting screen to directly issue a scan request.

### FIG. 20B Print-Settings Screen Displayed by Print-Settings-Screen Extension Unit 209

Next, FIG. 20B will be described. FIG. 20B illustrates a settings screen displayed by the print-settings-screen extension unit 209. A control 2013 is a print start button. A control 2014 is a print cancel button. In this embodiment, the print start button is displayed on the setting screen to directly issue a print request.

### FIG. 20C FAX-Settings Screen Displayed by FAX-Settings-Screen Extension Unit 221

Next, FIG. 20C will be described. FIG. 20C illustrates a settings screen displayed by the FAX-settings-screen extension unit 221. A control 2020 is a transmission start button. A control 2021 is a transmission cancel button. In this embodiment, the transmission start button is displayed on the setting screen to directly issue a transmission request.

In this embodiment, the application 1601 directly invokes the extension applications, as described above. This process allows printing, scanning, and FAX functions to be provided to the user with the same application.

The first embodiment and the third embodiment may be combined. For example, when the extension scanning application 214 is not present, the extension printing application 208, the general-purpose scanning software 204, and the extension FAX application 220 may be displayed as selectable options, and the selected one may be activated.

### Fourth Embodiment

A fourth embodiment of the present disclosure will be described hereinbelow. In the foregoing embodiments, function call buttons are always displayed for the application. However, depending on the hardware configuration of the image forming apparatus or the version of the software, there may be unsupported functions. For this reason, in the fourth embodiment, the application 201 displays a settings screen according to the capability response of the image forming apparatus. Only the difference from the foregoing embodiments will be described hereinbelow.

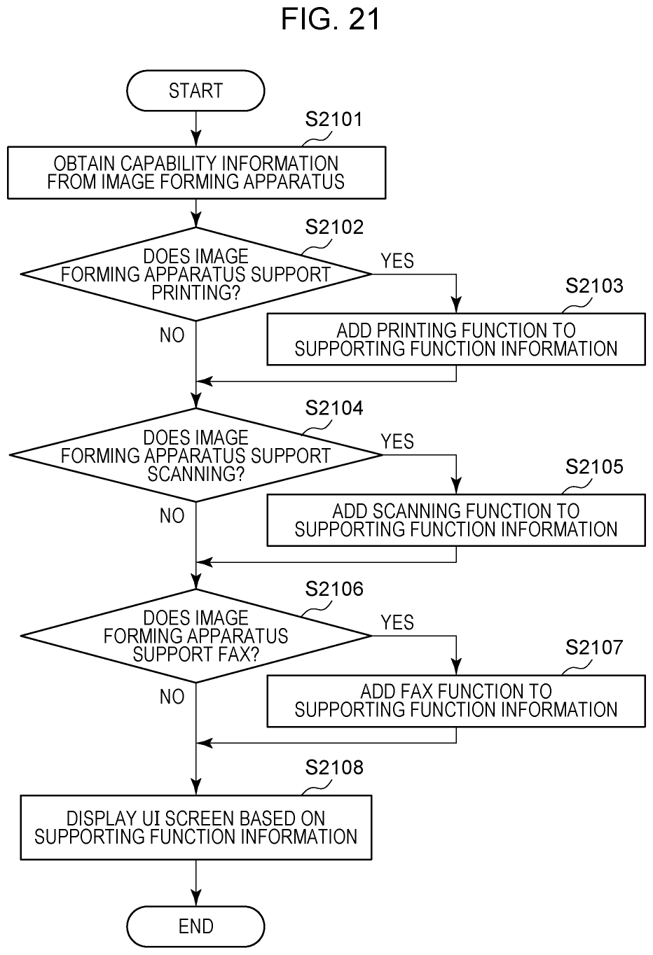

The processing flow in which the application 201 switches the screen display according to the capability response of the image forming apparatus 102 will be described with reference to FIG. 21. The operations (steps) illustrated in the flowchart of FIG. 21 are implemented by the CPU 191 executing programs stored in the RAM 193.

In S2101, the application 201 obtains capability information from the image forming apparatus 102. The capability information includes functions supported by the image forming apparatus 102, attribute information indicating items specified for the functions, and setting values related to the attribute information. For example, information indicating that printing, scanning, and FAX functions are supported is obtained from the image forming apparatus 102.

In addition, for the scanning function, items such as scan size and configurable options for each item can be obtained.

In this embodiment, the application 201 directly obtains capability information from the image forming apparatus 102. However, the printing-function extension unit 211, the scanning-function extension unit 217, and the FAX-function extension unit 223 of the extension applications 208, 214, and 220 may obtain capability information and pass the capability information to the application 201.

In step S2102, the CPU 191 determines whether the image forming apparatus 102 supports printing. If the CPU 191 determines that printing is not supported, the process proceeds to step S2104; otherwise, the process proceeds to step S2103. In step S2103, the CPU 191 adds a printing function to the supporting function information, and the printing function is stored in the RAM 113.

In step S2104, the CPU 191 determines whether the image forming apparatus 102 supports scanning. If the CPU 191 determines that scanning is not supported, the process proceeds to step S2106; otherwise, the process proceeds to step S2105. In step S2105, the CPU 191 adds a scanning function to the supporting function information, and the scanning function is stored in the RAM 113.

In step S2106, the CPU 191 determines whether the image forming apparatus 102 supports faxing. If the CPU 191 determines that faxing is not supported, the process proceeds to step S2108; otherwise, the process proceeds to step S2107. In step S2107, the CPU 191 adds a FAX function to the supporting function information, and the FAX function is stored in the RAM 113.

In step S2107, the CPU 191 displays a screen based on the supporting function information.

In this embodiment, the capability information of the image forming apparatus is obtained each time the application 201 is started. Also, the capability information may be obtained in advance and stored in the external storage 114, and the screen display may be switched based on the information.

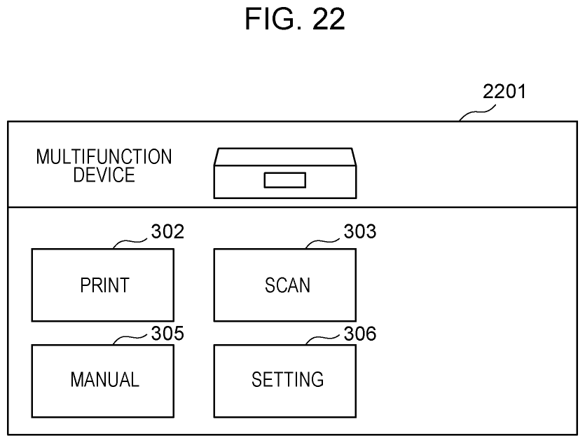

Next, an example of the application screen in this embodiment will be described with reference to FIG. 22. Reference numeral 2201 denotes a screen displayed by the application 201. In this embodiment, the printing and scanning functions are supported, and the FAX function is not supported as the result of the capability response from the image forming apparatus. Since the printing and scanning functions are supported, the print button of the control 302 and the scan button of the control 303 are displayed. In contrast, since the FAX function is not supported, the FAX button of the control 304 in FIG. 3 is not displayed.

In this embodiment, the unsupported function button is not displayed; also, it may be grayed out or shaded to indicate that it cannot be used.

In this embodiment, the application 201 obtains the capability of the image forming apparatus 102, as described above. The function to be displayed on the display screen is switched according to the obtained capability. This process allows the user to easily obtain the printing, scanning, and FAX functions.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-066076, which was filed on Apr. 16, 2024 and which is hereby incorporated by reference herein in its entirety.

What is claimed is:

1. A non-transitory computer-readable storage medium storing computer-executable instructions that, when executed, cause an information processing apparatus to perform a control method, the control method comprising:
generating an instruction executable in common by multifunction devices provided by a plurality of manufacturers; and
invoking a plurality of software capable of sending the instruction to the multifunction devices provided by the plurality of manufacturers.

2. The non-transitory computer-readable storage medium according to claim 1,
wherein the plurality of software includes two or more of software for generating print instructions, software for generating scan instructions, and software for generating FAX transmission instructions.

3. The non-transitory computer-readable storage medium according to claim 1, wherein the control method further comprises:
obtaining a function of a multifunction device; and
switching the software that can be invoked according to the obtained function of the multifunction device.

4. The non-transitory computer-readable storage medium according to claim 1, wherein the control method further comprises:
displaying a screen for selecting one from the plurality of software.

5. A non-transitory computer-readable storage medium storing computer-executable instructions that, when executed, cause an information processing apparatus to perform a control method, the control method comprising:
generating an instruction executable in common by multifunction devices provided by a plurality of manufacturers; and
invoking a plurality of support applications that supports respective functions of a plurality of software capable of sending the instruction to the multifunction devices provided by the plurality of manufacturers.

6. The non-transitory computer-readable storage medium according to claim 5, wherein the plurality of support applications includes two or more of a support application that supports software for generating print instructions, a support application that supports software for generating scan instructions, and a support application that supports software for generating FAX transmission instructions.

7. The non-transitory computer-readable storage medium according to claim 5, wherein the control method further comprises:
obtaining a function of a multifunction device; and
switching the software that can be invoked according to the obtained function of the multifunction device.

8. The non-transitory computer-readable storage medium according to claim 5, wherein the control method further comprises:
displaying a screen for selecting one from the plurality of software.

9. The non-transitory computer-readable storage medium according to claim 5, wherein the support application provides a settings screen for configuring a setting item that is not configurable on a settings screen provided by the software.

10. The non-transitory computer-readable storage medium according to claim 5, wherein the control method further comprises:
displaying a screen for selecting one from the plurality of support applications.

11. A control method for an information processing apparatus, the control method comprising:
generating an instruction executable in common by multifunction devices provided by a plurality of manufacturers; and
invoking a plurality of software capable of sending the instruction to the multifunction devices provided by the plurality of manufacturers.

12. The control method for the information processing apparatus according to claim 11,
wherein the plurality of software includes two or more of software for generating print instructions, software for generating scan instructions, and software for generating FAX transmission instructions.

13. The control method for the information processing apparatus according to claim 11, the control method further comprising:
obtaining a function of a multifunction device; and
switching the software that can be invoked according to the obtained function of the multifunction device.

14. The control method for the information processing apparatus according to claim 11, the control method further comprising:
displaying a screen for selecting one from the plurality of software.

15. A control method for an information processing apparatus, the control method comprising:
generating an instruction executable in common by multifunction devices provided by a plurality of manufacturers; and
invoking a plurality of support applications that supports respective functions of a plurality of software capable of sending the instruction to the multifunction devices provided by the plurality of manufacturers.

16. The control method for the information processing apparatus according to claim 15, wherein the plurality of support applications includes two or more of a support application that supports software for generating print instructions, a support application that supports software for generating scan instructions, and a support application that supports software for generating FAX transmission instructions.

17. The control method for the information processing apparatus according to claim 15, the control method further comprising:
obtaining a function of a multifunction device; and
switching the software that can be invoked according to the obtained function of the multifunction device.

18. The control method for the information processing apparatus according to claim 15, the control method further comprising:
displaying a screen for selecting one from the plurality of software.

19. The control method for the information processing apparatus according to claim 15, wherein the support application provides a settings screen for configuring a setting item that is not configurable on a settings screen provided by the software.

20. The control method for the information processing apparatus according to claim 15, the control method further comprising
displaying a screen for selecting one from the plurality of support applications.

21. A non-transitory computer-readable storage medium storing computer-executable instructions that, when executed, cause an information processing apparatus to perform a control method, the control method comprising:
generating an instruction executable in common by multifunction devices provided by a plurality of manufacturers;
displaying one or more of a plurality of software capable of sending the instruction to the multifunction devices provided by the plurality of manufacturers and one or more of a plurality of support applications that supports functions of the software as selectable options; and
invoking the selected software or support application.

22. A control method for an information processing apparatus including:
a plurality of software that generates an instruction executable in common by multifunction devices provided by a plurality of manufacturers and that is capable of sending the instruction to the multifunction devices provided by the plurality of manufacturers; and
a plurality of support applications that supports functions of the software, the control method comprising;
displaying one or more of the plurality of software and one or more of the plurality of support applications as selectable options; and
invoking the selected software or support application.
